(19) United States
(12) Patent Application Publication
(10) Pub. No.: US 2006/0132595 A1
(43) Pub. Date: Jun. 22, 2006

(54) Speakerphone supporting video and audio features

(76) Inventors: Michael L. Kenoyer, Austin, TX (US); Craig B. Malloy, Austin, TX (US); Wayne E. Mock, Round Rock, TX (US)

Correspondence Address: MEYERTONS, HOOD, KIVLIN, KOWERT & GOETZEL, P.C., 700 LAVACA, SUITE 800, AUSTIN, TX, 78701, US

(21) Appl. No.: 11/251,086

(22) Filed: Oct. 14, 2005

Related U.S. Application Data
(60) Provisional application No. 60/619,212, filed on Oct. 15, 2004.
(60) Provisional application No. 60/676,048, filed on Apr. 29, 2005.

(51) Int. Cl. H04N 7/14

(52) U.S. Cl. 348/14.08; 348/14.01

(57) ABSTRACT

In various embodiments, a speakerphone and/or remote control may be used to control a video conferencing system through a system codec. In some embodiments, video conferencing features may be provided through the speakerphone and/or remote control. For example, features to manage video calls, audio calls, and bridging multiple video and/or audio calls into a single conference may be accessed through a keypad on the speakerphone, a remote control, and/or through a video conference system. Options and indicators may be provided on a screen of the speakerphone and/or video conferencing system. In some embodiments, a video call may be dialed, redialed, muted, answered, added to an existing conference, and/or terminated using a speakerphone and/or remote control. In some embodiments, a call length timer may be implemented, the volume may be adjusted, or a camera may be adjusted through a speakerphone and/or remote control.

### PRIORITY

This application claims priority to U.S. provisional patent application Ser. No. 60/619,212, entitled “Video Conferencing Speakerphone” which was filed Oct. 15, 2004, whose inventors are Michael L. Kenoyer, Craig B. Malloy, and Wayne E. Mock, which is hereby incorporated by reference in its entirety as though fully and completely set forth herein.

This application claims priority to U.S. provisional patent application Ser. No. 60/676,048, entitled “Speakerphone Supporting Video and Audio Features” which was filed Apr. 29, 2005, whose inventors are Wayne E. Mock, which is hereby incorporated by reference in its entirety as though fully and completely set forth herein.

### BACKGROUND OF THE INVENTION

1. Field of the Invention

The present invention relates generally to conferencing systems and, more specifically, to video/speakerphone conferencing systems.

2. Description of the Related Art

Speakerphones are used in many types of telephone calls, and particularly, in conference calls between multiple people at various locations. Typically, speakerphones have several microphones to pick up voices of participants at a first location, and at least one speaker to present sound from voices of participants in a second location. A speakerphone may detect sound in a first location and send a signal over a network (e.g., a Plain Old Telephone Service (POTS) network) to another phone (e.g., another speakerphone) that may reproduce the sound in the second location. The other speakerphone may produce the sound over a speaker for multiple participants in the second location to hear. Other speakerphones in other locations may also be connected to the call.

A video conferencing system may also be used to transmit signals for sound and visual images of participants at a first location to one or more video conferencing systems in other locations. However, controlling the video conferencing system may be difficult. For example, controls for the video conference system may be restricted to the video conferencing system only.

### SUMMARY OF THE INVENTION

In various embodiments, a speakerphone and/or remote control may be used to control a video conferencing system through a system codec. In some embodiments, video conferencing features may be provided through the speakerphone and/or remote control. For example, features to manage video calls, audio calls, and bridging multiple video and/or audio calls into a single conference may be accessed through a keypad on the speakerphone, a remote control, and/or through a video conference system. Options and indicators may be provided on a screen of the speakerphone and/or video conferencing system.

In some embodiments, a video call may be dialed, redialed, muted, answered, added to an existing conference, and/or terminated using a speakerphone and/or remote control. In some embodiments, a call length timer may be implemented, the volume may be adjusted, or a camera may be adjusted through a speakerphone and/or remote control.

In some embodiments, a context sensitive consult feature may be used when adding new outgoing or incoming calls. In some embodiments, the context sensitive consult feature may be used to consult new callers in a separate conference and then optionally add the new callers to an existing conference.

In some embodiments, options and indicators may be displayed on the video conference screen. In some embodiments, phone number panels may have numbers listed that are currently connected in the conference call. A “Hang up all” option may be selected to hang up all of the numbers. A “Hang up voice” option may be selected to hang up the voice callers. A “Hang up video” option may be selected to hang up the video callers. An “Add call” option may be selected to dial another number to add to the conference call. In some embodiments, an icon may be used to indicate on the screen which camera is being used.

In some embodiments, when a call is received, an incoming call panel with options to “Answer” the call or “Ignore the call”. In some embodiments, information about the incoming call may be displayed (e.g., in panel). Other options and information may also be used. In some embodiments, the number of the incoming call may also be displayed (not shown).

In some embodiments, additional options may be provided. For example, an “Answer” option may answer the incoming call. The “Consult” option may answer the call but not join it to a current conference. An “Ignore call” option may be selected to ignore the call. A “Do not disturb” option may be selected to ignore all future calls until the current call is ended (or, for example, a certain amount of time passes). In some embodiments, if a “Consult” option is selected and the incoming call is over the speakerphone, a “Voice only consult” message may be displayed.

### BRIEF DESCRIPTION OF THE DRAWINGS

A better understanding of the present invention may be obtained when the following detailed description is considered in conjunction with the following drawings, in which:

FIG. 1 illustrates a speakerphone with a center speaker and multiple microphones, according to an embodiment;

FIG. 2 illustrates a circuitry diagram of the speakerphone, according to an embodiment;

FIGS. 3a and 3b illustrates a speakerphone and video conferencing system used together with an accompanying memory medium, according to an embodiment;

FIGS. 4a and 4b illustrate numeric keypads for a speakerphone, according various embodiments;

FIG. 5 illustrates a remote control for a video conferencing system, according to an embodiment;

FIG. 6 illustrates a method for placing a call from a speakerphone, according to an embodiment;

FIG. 7 illustrates a method for placing a video call from the speakerphone, according to an embodiment;

FIG. 8 illustrates a method for placing a voice call from the speakerphone, according to an embodiment;

FIG. 9 illustrates a screenshot of the speakerphone dialing a voice call, according to an embodiment;

FIG. 10 illustrates a screenshot of the speakerphone ringing a voice number, according to an embodiment;

FIG. 11 illustrates a method for redialing the last call from the speakerphone, according to an embodiment;

FIG. 12 illustrates a method for accepting incoming video calls from the speakerphone, according to an embodiment;

FIG. 13 illustrates a method for accepting an incoming voice call from the speakerphone, according to an embodiment;

FIG. 14 illustrates a method for terminating the video call from the speakerphone, according to an embodiment;

FIG. 15 illustrates a method for terminating the current voice call from the speakerphone, according to an embodiment;

FIG. 16 illustrates a method for video call termination, according to an embodiment;

FIG. 17 illustrates a method for voice call termination, according to an embodiment;

FIG. 18 illustrates a screenshot of a voice call termination, according to an embodiment;

FIG. 19 illustrates a method for popping video call length timer, according to an embodiment;

FIG. 20 illustrates a method for muting audio of the current call, according to an embodiment;

FIG. 21 illustrates a screenshot for muting a call, according to an embodiment;

FIG. 22 illustrates a method for un-muting the current call, according to an embodiment;

FIG. 23 illustrates a method for changing the volume of the current call, according to an embodiment;

FIG. 24 illustrates a screenshot of increasing the volume, according to an embodiment;

FIG. 25 illustrates a method for adding other callers to the conference from the speakerphone, according to an embodiment;

FIG. 26 illustrates a screenshot for pressing the add button to add a new call during a voice only conference call, according to an embodiment;

FIG. 27 illustrates a screenshot for pressing the add button to add a new call during a video and voice conference call, according to an embodiment;

FIG. 28 illustrates a screenshot for adding other callers to conference from the speakerphone, according to an embodiment;

FIG. 29 illustrates a screenshot for adding or hanging up current call, according to an embodiment;

FIG. 30 illustrates a screenshot of participating in a voice and video call, according to an embodiment;

FIG. 31 illustrates a method for accepting incoming callers to conference from the speakerphone, according to an embodiment;

FIG. 32 illustrates a method for terminating multipoint video call from the speakerphone, according to an embodiment;

FIG. 33 illustrates a method for placing a video call with the remote control, according to an embodiment;

FIG. 34 illustrates a method for placing a voice call with the remote control, according to an embodiment;

FIG. 35 illustrates a method for redialing last call(s) with the remote control, according to an embodiment;

FIG. 36 illustrates a method for accepting incoming video call with the remote control, according to an embodiment;

FIG. 37 illustrates a method for accepting incoming voice call with the remote control, according to an embodiment;

FIG. 38 illustrates a method for terminating the current call with the remote control, according to an embodiment;

FIG. 39 illustrates a method for picking up the remote control, according to an embodiment;

FIG. 40 illustrates a method for putting down the remote control, according to an embodiment;

FIG. 41 illustrates a method for adding another caller to the conference with the remote control, according to an embodiment;

FIG. 42 illustrates a method for accepting an incoming caller to conference with the remote control, according to an embodiment;

FIG. 43 illustrates a method for changing volume from a speakerphone during a video call with an added voice call, according to an embodiment;

FIG. 44 illustrates a method for changing volume with remote control during a video call with an added voice call, according to an embodiment;

FIG. 45 illustrates a method for terminating an individual connection in a multipoint call, according to an embodiment;

FIG. 46 illustrates a method for activating a secondary input, according to an embodiment;

FIG. 47 illustrates a method for selecting a near camera for control, according to an embodiment;

FIG. 48 illustrates a method for selecting a far camera for control, according to an embodiment;

FIG. 49 illustrates a method for selecting a new camera for control during continuous presence, according to an embodiment;

FIG. 50 illustrates a method for panning a camera, according to an embodiment;

FIG. 51 illustrates a method for tilting a camera, according to an embodiment;

FIG. 52 illustrates a method for zooming a camera, according to an embodiment;

FIG. 53 illustrates a method for selecting near video input, according to an embodiment;

FIG. 54 illustrates a method for selecting a far video input, according to an embodiment;

FIG. 55 illustrates a method for moving a camera to a preset position with the remote control, according to an embodiment;

FIG. 56 illustrates a method for setting the camera position preset with the remote control, according to an embodiment;

FIG. 57 illustrates a method for centering a camera with remote control, according to an embodiment;

FIG. 58 illustrates a method for centering a camera with a speakerphone, according to an embodiment;

FIG. 59 illustrates a method for manually suspending the system, according to an embodiment;

FIG. 60 illustrates a method for manually resuming the system, according to an embodiment;

FIG. 61 illustrates a method for restarting the system, according to an embodiment;

FIG. 62 illustrates a method for placing a call from an address book, according to an embodiment;

FIG. 63 illustrates a method for detecting abnormal video call termination, according to an embodiment;

FIG. 64 illustrates a method for setting camera position preset with speakerphone, according to an embodiment;

FIG. 65 illustrates a method for moving a camera to a preset position using the speakerphone, according to an embodiment;

FIG. 66 illustrates a method for centering camera with the speakerphone, according to an embodiment;

FIG. 67 illustrates a main video conferencing system screenshot, according to an embodiment;

FIG. 68 illustrates a screenshot of dialing a voice call, according to an embodiment;

FIG. 69 illustrates a screenshot of a voice only conference call, according to an embodiment;

FIG. 70 illustrates a screenshot of adding a video call, according to an embodiment;

FIG. 71 illustrates a screenshot of a video/voice call and/or consulting a video caller, according to an embodiment;

FIG. 72 illustrates a screenshot of joining a conference call, according to an embodiment;

FIG. 73 illustrates a screenshot of hanging up a video/voice call, according to an embodiment;

FIG. 74 illustrates a screenshot of receiving a call when no other calls are connected, according to an embodiment;

FIG. 75 illustrates a screenshot of additional incoming calls when at least one other call is already connected, according to an embodiment;

FIG. 76 illustrates a screenshot of a voice only consult, according to an embodiment;

FIG. 77 illustrates a method for using a speakerphone in a video conference, according to an embodiment;

FIG. 78 illustrates a method for consulting a participant separate from a video conference, according to an embodiment;

FIG. 79 illustrates an integrated video conferencing and speakerphone unit;

FIG. 80 illustrates an integrated unit key pad, according to an embodiment;

FIG. 81 illustrates a circuit diagram of a video conferencing and speakerphone unit, according to an embodiment; and

FIG. 82 illustrates an internal view of a camera, according to an embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must). The term “include”, and derivations thereof, mean “including, but not limited to”. The term “coupled” means “directly or indirectly connected”.

### DETAILED DESCRIPTION OF THE EMBODIMENTS

### Incorporation by Reference

U.S. Provisional Patent Application titled “Speakerphone”, Ser. No. 60/619,303, which was filed Oct. 15, 2004, whose inventors are William V. Oxford, Michael L. Kenoyer, and Simon Dudley is hereby incorporated by reference in its entirety as though fully and completely set forth herein.

U.S. Provisional Patent Application titled “Speakerphone”, Ser. No. 60/634,315 which was filed Dec. 8, 2004, whose inventors are William V. Oxford, Michael L. Kenoyer and Simon Dudley which is hereby incorporated by reference in its entirety as though fully and completely set forth herein.

U.S. Provisional Patent Application titled “Video Conference Call System”, Ser. No. 60/619,210, which was filed Oct. 15, 2004, whose inventors are Jonathan W. Tracey, Craig B. Malloy, Michael L. Kenoyer, Michael V. Jenkins, Ashish Goyal, and Michael J. Burkett, is hereby incorporated by reference in its entirety as though fully and completely set forth herein.

U.S. Provisional Patent Application titled “High Definition Camera and Mount”, Ser. No. 60/619,227, which was filed Oct. 15, 2004, whose inventors are Michael L. Kenoyer, Patrick D. Vanderwilt, Paul D. Frey, Paul Leslie Howard, Jonathan I. Kaplan, and Branko Lukic, is hereby incorporated by reference in its entirety as though fully and completely set forth herein.

In various embodiments, a video conference system may be controlled by a speakerphone and/or remote control. In some embodiments, the speakerphone may be coupled to a system codec 309 to control the video conference system. While the speakerphone may be used separately, the speakerphone may also be used in conjunction with the video conference system.

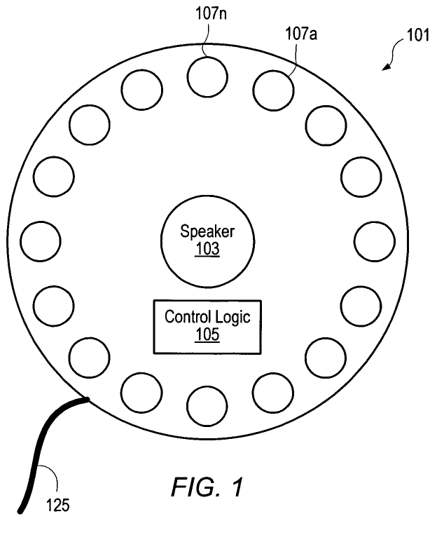

As seen in FIG. 1, a speakerphone 101 may have a center speaker 103 and multiple microphones 107, which may circle the outer perimeter of the speakerphone 101. The center speaker 103 may provide sound from offsite participants, while the microphones 107 may capture sound from in-room participants. In some embodiments, 16 microphones 107 may be radially distributed around the center speaker 103. Other numbers of microphones and speakers may also be used. The microphones 107 may be radially distributed to enhance detection of an in-room participant's voice from multiple angles relative to the speakerphone 101. While a circular arrangement for the microphones 107 is shown, other arrangements may also be used. The microphones 107 and speakers 103 may also be arranged differently. In some embodiments, a control logic 105 may control the speaker 103, microphones, 107, and other various functions of the speakerphone 101. In some embodiments, the speakerphone 101 may include a port for coupling to a telephone jack and a plurality of user input elements (e.g., buttons) for receiving user input to manipulate one or more characteristics of a video conference. In some embodiments, the speakerphone 101 may be coupled to other devices (e.g., the system codec) through a cable 125 (e.g., an Ethernet cable).

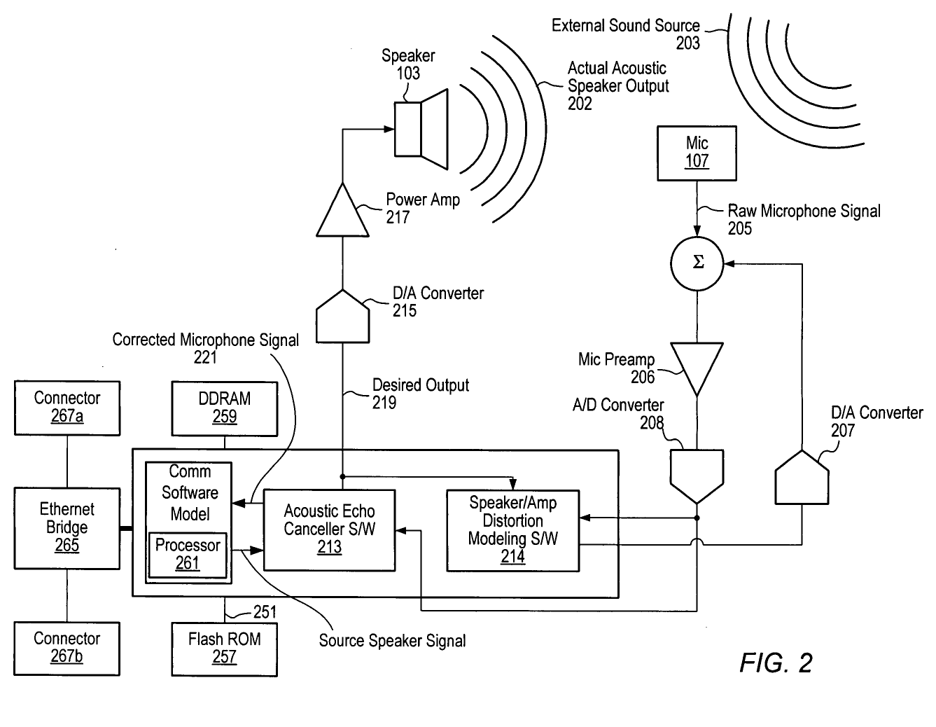

FIG. 2 illustrates a diagram of an embodiment of the speakerphone circuitry (i.e., the control logic 105). In some embodiments, a processor 261, such as a Phillips Nexperia PNX 1500 DSP, may control various components of the speakerphone 101. The processor 261 may be coupled to a memory such as a flash memory 257 and a double data random access memory (DDRAM) 259. Other memories and memory types may also be used. In some embodiments, the processor 261 may be coupled to components (e.g., flash memory 257) through a peripheral component interconnect (PCI) interface 251. The speakerphone 101 may include various connectors 267 to connect the speakerphone 101 to a network, such as an Ethernet, through an Ethernet bridge 265. Other networks are also contemplated. In some embodiments, connectors 267 may be used to daisy chain additional speakerphones. For example, multiple speakerphones may be used in a large conference room.

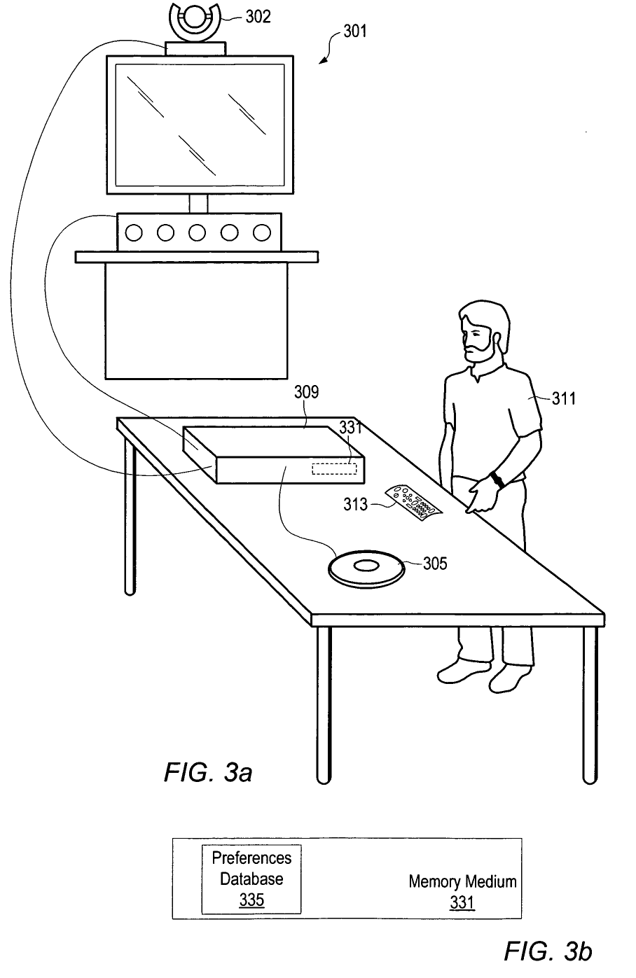

FIG. 3 illustrates a speakerphone 305 and video conferencing system 301 used together, according to an embodiment. In some embodiments, video conferencing features may be provided through a speakerphone 305. For example, features to manage video calls, audio calls, and bridging multiple video and/or audio calls into a single conference may be accessed through a keypad on the speakerphone 305 and/or remote control 313. In some embodiments, a camera 302 may be used. In some embodiments, if multiple speakerphones are daisy chained together, features to manage calls may be accessible from each of the phones. In some embodiments, a context sensitive consult feature may be used when adding new outgoing or incoming calls. Several exemplary embodiments are provided below.

In some embodiments, the speakerphone 101 may communicate with a system codec 309 (or other system interface) over an interface such as an Ethernet cable between the speakerphone 101 and the system codec 309. For example, the speakerphone 101 may communicate with the system codec 309 to indicate which button(s) the user has pressed on the speakerphone 101. The system may then implement a functionality that corresponds to the pressed button. In some embodiments, a driver on the speakerphone 101 may facilitate communication with the video conferencing system through the system codec 309. For example, the driver on the speakerphone 101 may communicate over the Ethernet cable with the system codec 309 using Linux™ named pipes. Other communication mediums and transmission protocols may also be used (e.g., the speakerphone may communicate with the system codec 309 over a wireless connection).

In some embodiments, speakerphones may also communicate with other devices coupled to the speakerphone (e.g., a daisychained speakerphone). For example, speakerphones may pass messages over an Ethernet cable coupling the speakerphones in order to synchronize their processor clocks (this may allow the clock synchronization to be fine tuned for better echo cancellation). Other information may also be communicated from the speakerphone. In some embodiments, the speakerphones may transmit an audio signal over the Ethernet cable through a User Datagram Protocol (UDP) (other protocols are also contemplated).

In some embodiments, the system codec 309 may maintain a preferences database 335 (e.g., on a memory medium 331 in the system codec 309 as seen in FIGS. 3a and 3b). The database may keep track of the status of different components and/or functions on the speakerphone 101 and video conferencing system. Many different components may access the database and/or change the status of different components and/or functions stored in the database. For example, the database may maintain the current status of the speakerphone mute button (e.g., the status may include mute active). The mute button status may be changed, for example, by pressing the mute button on the speakerphone 101. Other components with access to the database may request to be notified whenever the status of certain components/functions changes. For example, the mute light on the speakerphone 101 and a video screen mute indicator may have standing requests with the database to notify them if the status of the speakerphone mute button changes (e.g., to illuminate the mute light and show the mute icon on the video screen when the mute button is pressed). In some embodiments, statuses in the database may be defined as volatile or non-volatile (e.g., written to flash such that if the system is loses power, the status is stored).

In some embodiments, a daisy chained speakerphone may also be notified that the mute button was pressed. Both speakerphones may then be muted (or each may be muted separately). In addition, pressing the mute button on one of the speakerphones may also mute the video conferencing system. The database may be accessed by other processors and other system repositories. In some embodiments, the database may have a hierarchy (e.g., similar components may be stored in the same category). Devices may have standing requests to be notified anytime any component/function in a certain category has changed. For example, the mute light may be in a category with other system lights (e.g., Lights: Speakerphone: Mute). A component with a standing request to be notified if the status of a component/function in the light category changes may be notified if the mute light status changes.

In some embodiments, the speakerphone 101 may be a general purpose speakerphone and may be a slave device to the system codec. In some embodiments, the speakerphone may be powered over ethernet (POE ethernet). In some embodiments, adaptors may be used to power the speakerphone over Ethernet. The system codec may produce the POE power over the Ethernet. In some embodiments, the speakerphone and system codec may perform handshaking so the system codec knows when the speakerphone is connected.

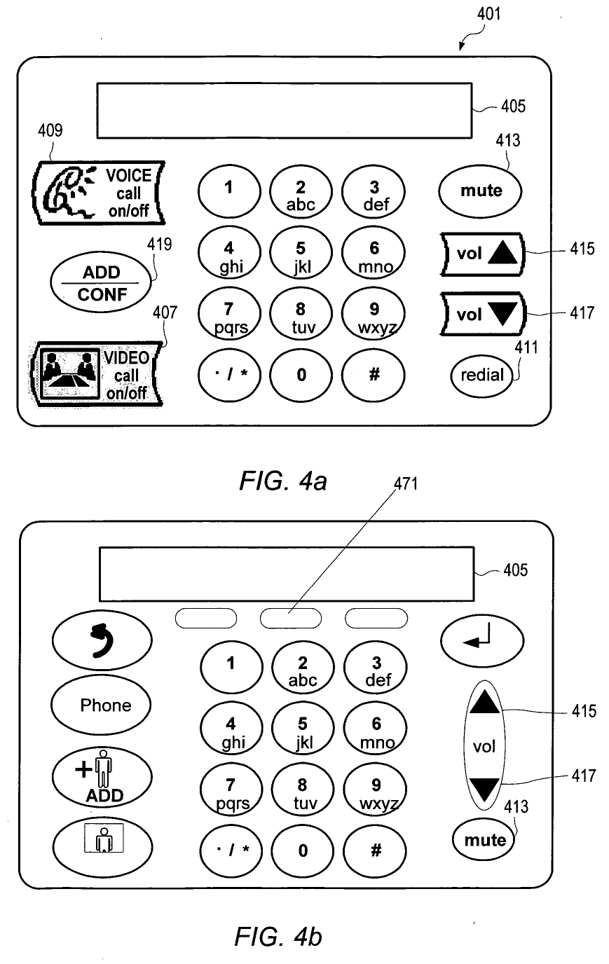

FIGS. 4a and 4b illustrate embodiments of a speakerphone keypad. As seen in FIG. 4a, buttons on the keypad 401 may include voice call 409, add/conf 419, video call 407, mute 413, volume up 415, volume down 417, redial 411, and the general numeric buttons. The speakerphone may also have a screen 405. As seen in FIG. 4b, menu selector buttons 471 under the screen may be used to select one or more options on the screen. In some embodiments, lights (e.g., light emitting diodes (LEDs) may be illuminated behind the buttons on the keypad). In some embodiments, when a button is pressed on the speakerphone, a corresponding signal may be sent to the video conferencing system. In some embodiments, users may access multipoint conferencing units (MCUs) and automated tellers through the speakerphone keypad. It may be easier to dial the numbers with the speakerphone keypad on the table in front of the user.

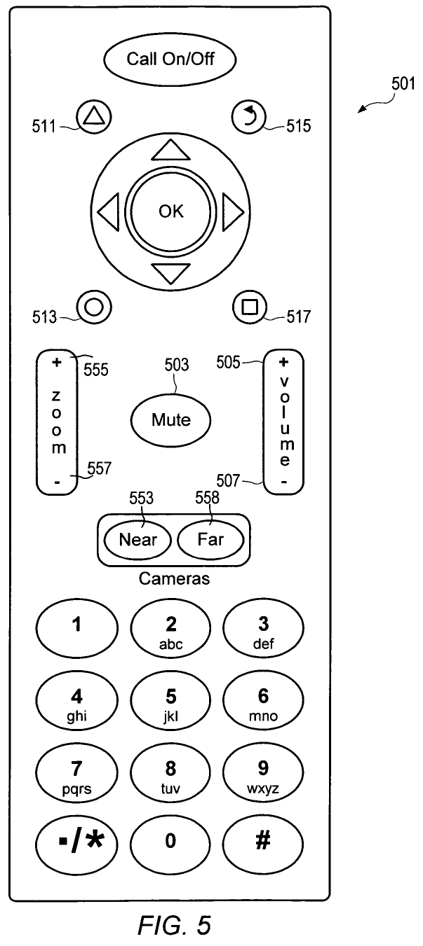

FIG. 5 illustrates an embodiment of a remote control. In some embodiments, the remote control may also be used to control the conference system. Buttons on the remote control may include designators 511, 513, 515, and 517, mute 503, volume up 505, volume down 507, zoom in 555, zoom out 557, near camera 553, far camera 558, call on/off 567, and general numeric buttons. Other buttons may also be included.

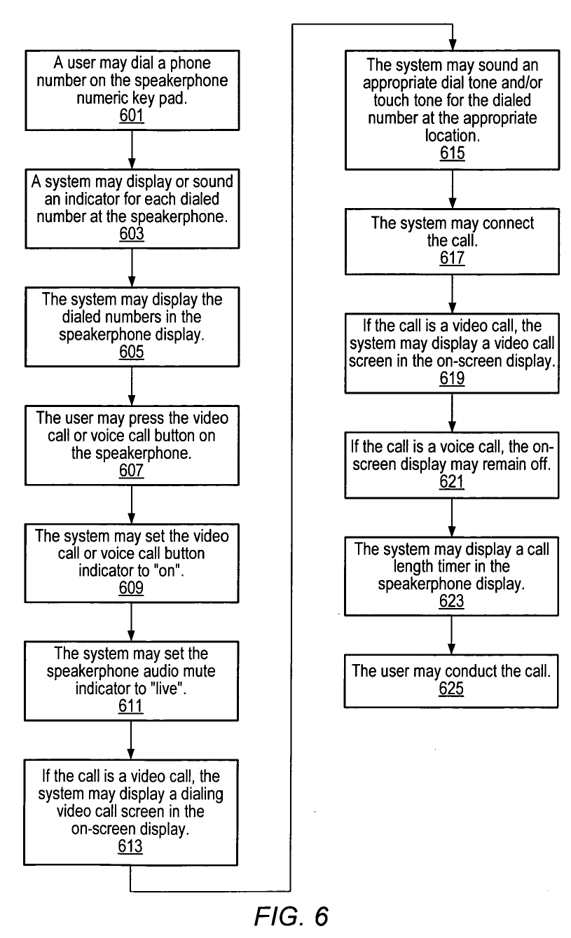

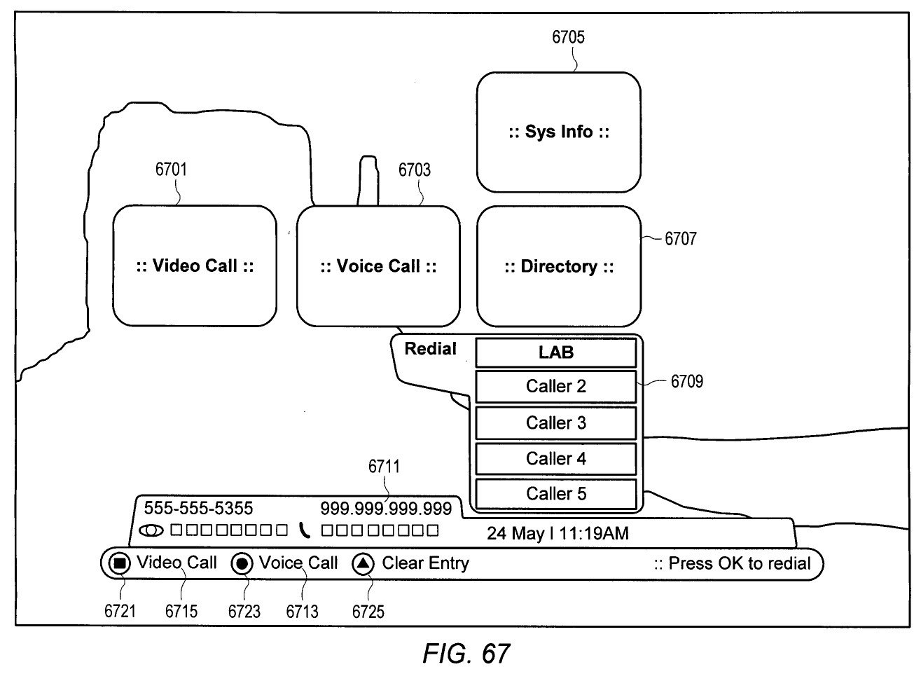

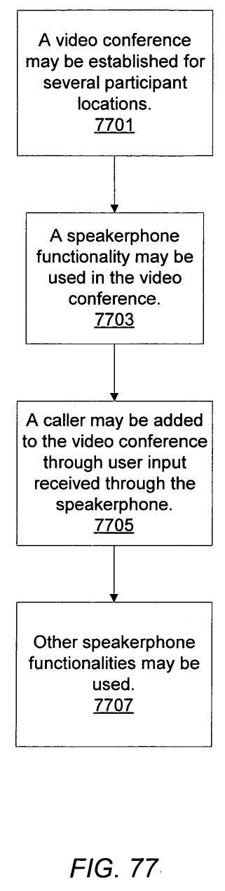

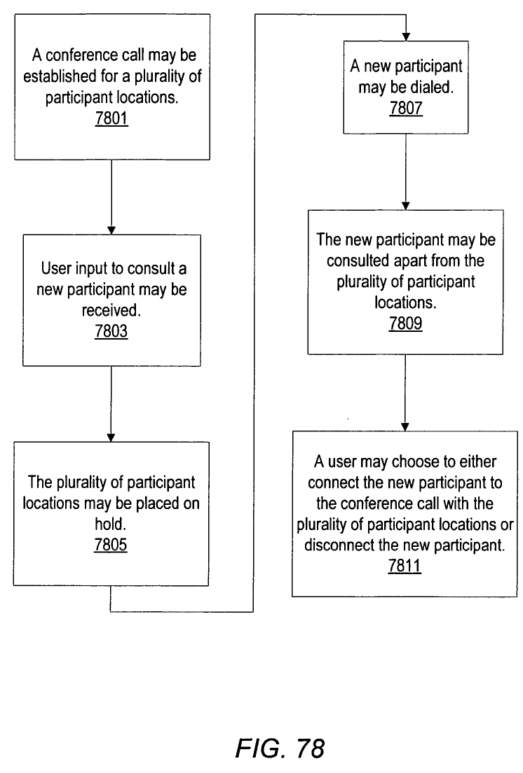

Several embodiments are described below. FIGS. 6-66 illustrate various embodiments of speakerphone and remote control functionality in a video conference. FIGS. 67-76 illustrate embodiments of screen shots for the video conference, and FIGs. 77-78 illustrate various speakerphone functionalities that may be used in a video conference.

FIG. 6 illustrates a method for placing a call from a speakerphone, according to an embodiment. It is noted that in various embodiments one or more of the method elements may be performed concurrently, in a different order, or be omitted. Additional elements may be performed as desired.

At 601, a user may dial a phone number on the speakerphone numeric keypad 401 (as seen in FIG. 4). In some embodiments, the user may dial a phone number on the remote control 501 (as seen in FIG. 5).

At 603, the system may display or sound an indicator for each dialed number at the speakerphone.

At 605, the system may display the dialed numbers in the speakerphone display 405.

At 607, the user may press the video call button 407 or voice call button 409 on the speakerphone (depending on the type of call being made).

At 609, the system may set the video call or voice call button indicator to “on”. For example, a light may illuminate the video call 407 or voice call button 409 to indicate “on”. In some embodiments, an indicator in the speakerphone display 405 may be activated.

At 611, the system may set the speakerphone audio mute indicator to “live”. For example, when the speakerphone audio mute indicator is “live”, the mute button may not be illuminated. In some embodiments, a symbol (not shown) may appear on the speakerphone display 405 to indicate whether the mute feature is currently enabled.

At 613, if the call is a video call, the system may display a dialing video call screen in the on-screen display (i.e., the video screen display).

At 615, the system may sound an appropriate dial tone and/or touch tone for the dialed number at the appropriate location (e.g., speakerphone or endpoint). In some embodiments, different tones may be sounded from the speakerphone for different buttons.

At 617, the system may connect the call.

At 619, if the call is a video call, the system may display a video call screen in the on-screen display.

At 621, if the call is a voice call, the on-screen display may remain off.

At 623, the system may display a call length timer in the speakerphone display 405. For example, a timer may appear on the speakerphone display 405 and may increment upward as the call progresses. In some embodiments, the time may time out or “pop” at a preset time. The call may be ended or confirmation to continue the call may be requested when the timer times out (e.g., at a predetermined time).

At 625, the user may conduct the call.

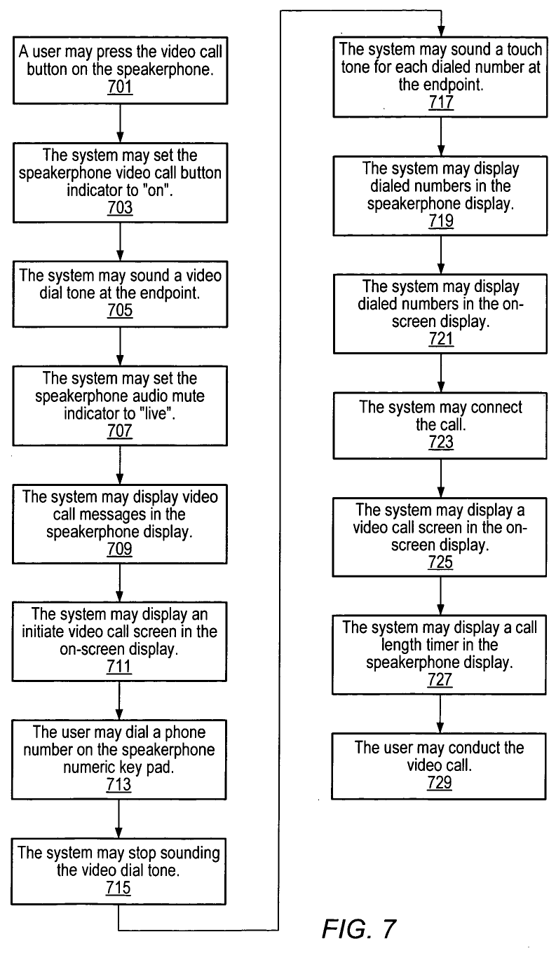

FIG. 7 illustrates a method for placing a video call from the speakerphone, according to an embodiment. It is noted that in various embodiments one or more of the method elements may be performed concurrently, in a different order, or be omitted. Additional elements may be performed as desired.

At 701, a user may press the video call button 407 on the speakerphone.

At 703, the system may set the speakerphone video call button indicator to “on”.

At 705, the system may sound a video dial tone at the endpoint. In some embodiments, the video dial tone may sound different than the dial tone for an audio call. In some embodiments, the dial tone for an audio call and video call may be sounded through the speakerphone. In some embodiments, each may be sounded through their respective systems (e.g., audio call dial tone through speakerphone and video call dial tone through the video conference system).

At 707, the system may set the speakerphone audio mute indicator to “live”.

At 709, the system may display a “video call” message in the speakerphone display 405.

At 711, the system may display an initial video call screen in the speakerphone display 405.

At 713, the user may dial a phone number on the speakerphone numeric keypad 471.

At 715, the system may stop sounding the video dial tone.

At 717, the system may sound a touch tone for each dialed number at the endpoint.

At 719, the system may display dialed numbers in the speakerphone display 405.

At 721, the system may display dialed numbers in the on-screen display.

At 723, the system may connect the call.

At 725, the system may display a video call screen in the on-screen display.

At 727, the system may display a call length timer in the speakerphone display 405.

At 729, the user may conduct the video call.

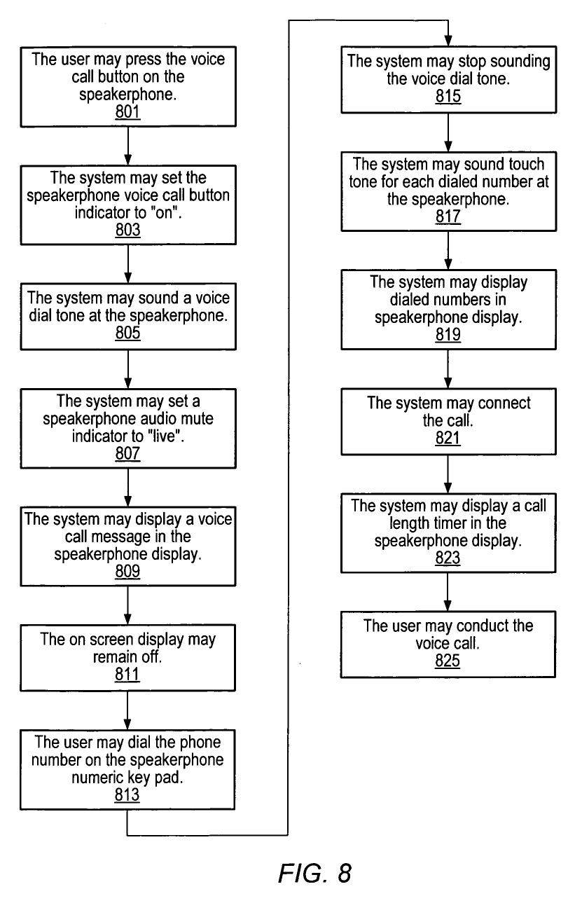

FIG. 8 illustrates a method for placing a voice call from the speakerphone, according to an embodiment. It is noted that in various embodiments one or more of the method elements may be performed concurrently, in a different order, or be omitted. Additional elements may be performed as desired.

At 801, the user may press the voice call button 409 on the speakerphone.

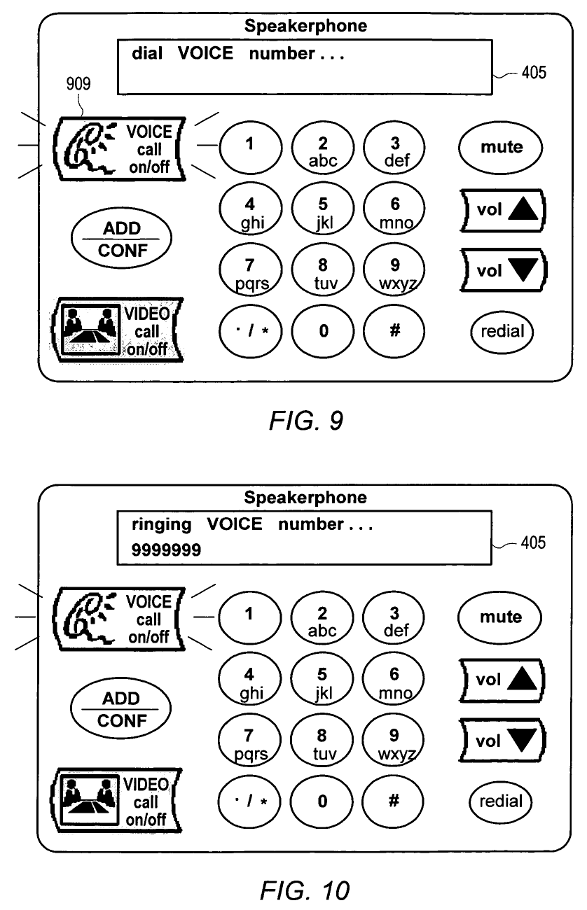

At 803, the system may set the speakerphone voice call button indicator to “on”. For example, as seen in FIG. 9, the voice call button 909 may be illuminated.

At 805, the system may sound a voice dial tone at the speakerphone.

At 807, the system may set a speakerphone audio mute indicator to “live”.

At 809, the system may display a voice call message in the speakerphone display 405. For example, as seen in FIG. 9, the message “dial VOICE number . . . ” may be displayed.

At 811, the on screen display (i.e., the video screen display) may remain off.

At 813, the user may dial the phone number on the speakerphone numeric keypad 301.

At 815, the system may stop sounding the voice dial tone.

At 817, the system may sound touch tone for each dialed number at the speakerphone.

At 819, the system may display dialed numbers in speakerphone display 405. As seen in FIG. 10, the dialed numbers may appear in the display 405.

At 821, the system may connect the call.

At 823, the system may display a call length timer in the speakerphone display 405.

At 825, the user may conduct the voice call. In some embodiments, the user may press add to add another caller to the voice call. For example, the added call may be a video call. A video call indicator may appear in the speakerphone display 405 to indicate that a video call is also connected. In some embodiments, a caller, such as a video caller may be consulted separately instead of being added to the call. For example, after a number is dialed for a separate call, a user may choose not to add the call to the conference call, but may instead consult the separate caller and then terminate the call before rejoining the conference call. In some embodiments, adding another line may be supported for a private branch exchange (PBX) which may include a private telephone switchboard. Other PBX functions may also be supported through the speakerphone.

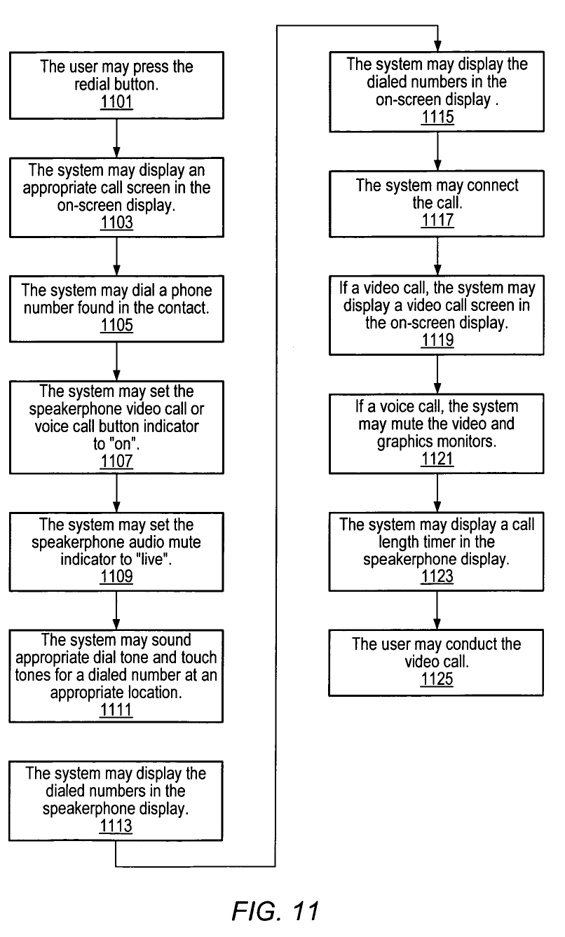

In some embodiments, a user may press the add video button (or voice button), dial a number and be connected without using a consult feature (e.g., the other connected callers may hear what is taking place.) FIG. 11 illustrates a method for redialing the last call from the speakerphone, according to an embodiment. It is noted that in various embodiments one or more of the method elements may be performed concurrently, in a different order, or be omitted. Additional elements may be performed as desired.

At 1101, the user may press the redial button 411.

At 1103, the system may display an appropriate call screen in the on-screen display (video only).

At 1105, the system may dial a phone number found in the contact.

At 1107, the system may set the speakerphone video call or voice call button indicator to “on” (depending on the type of call).

At 1109, the system may set the speakerphone audio mute indicator to “live”.

At 1111, the system may sound an appropriate dial tone (e.g., a video or voice dial tone) and touch tones for a dialed number at an appropriate location (endpoint or speakerphone).

At 1113, the system may display the dialed numbers in the speakerphone display 405.

At 1115, the system may display the dialed numbers in the on-screen display (video only).

At 1117, the system may connect the call.

At 1119, if a video call, the system may display a video call screen in the on-screen display.

At 1121, if a voice call, the system may mute the video monitor.

At 1123, the system may display a call length timer in the speakerphone display 405.

At 1125, the user may conduct the video call.

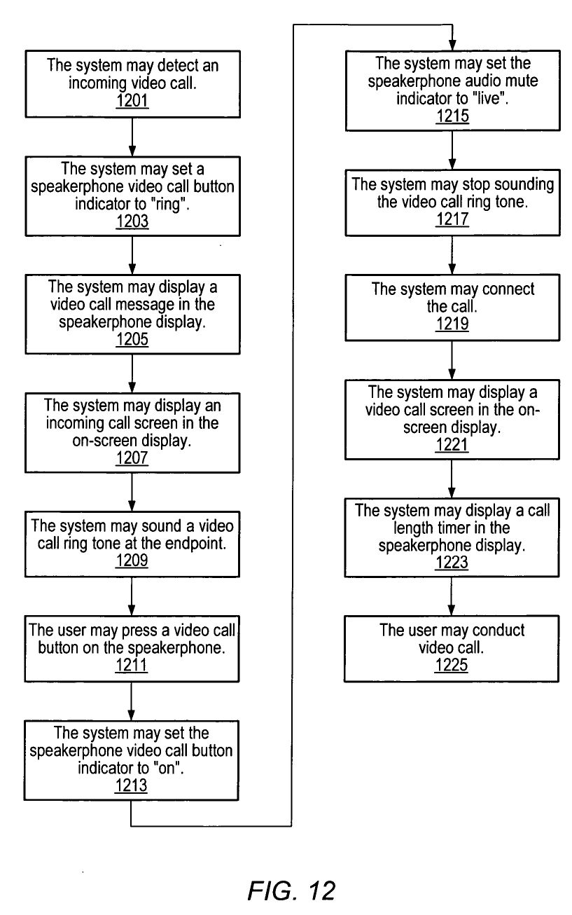

FIG. 12 illustrates a method for accepting incoming video calls from the speakerphone, according to an embodiment. It is noted that in various embodiments one or more of the method elements may be performed concurrently, in a different order, or be omitted. Additional elements may be performed as desired.

At 1201, the system may detect an incoming video call.

At 1203, the system may set a speakerphone video call button indicator to “ring”. For example, a light illuminating the video call button may blink. In some embodiments, an indicator may appear on the on screen display to indicate a video call “ring”.

At 1205, the system may display a video call message in the speakerphone display 405.

At 1207, the system may display an incoming call screen in the on-screen display.

At 1209, the system may sound a video call ring tone at the endpoint.

At 1211, the user may press a video call button 407 on the speakerphone.

At 1213, the system may set the speakerphone video call button indicator to “on”.

At 1215, the system may set the speakerphone audio mute indicator to “live”.

At 1217, the system may stop sounding the video call ring tone.

At 1219, the system may connect the call.

At 1221, the system may display a video call screen in the on-screen display.

At 1223, the system may display a call length timer in the speakerphone display 405.

At 1225, the user may conduct the video call.

FIG. 13 illustrates a method for accepting incoming voice call from the speakerphone, according to an embodiment. It is noted that in various embodiments one or more of the method elements may be performed concurrently, in a different order, or be omitted. Additional elements may be performed as desired.

At 1301, the system may detect an incoming voice call.

At 1303, the system may set the speakerphone voice call button indicator to “ring”. For example, a light illuminating the voice call button may blink. In some embodiments, an indicator may appear on the speakerphone display 405 to indicate a voice call “ring”.

At 1305, the system may display a voice call message in the speakerphone display 405.

At 1307, the system may sound a voice call ring tone at the speakerphone.

At 1309, the user may press a voice call button 409 on the speakerphone.

At 1311, the system may set a speakerphone voice call button indicator to “on”.

At 1313, the system may set a speakerphone audio mute indicator to “live”.

At 1315, the system may stop playing voice call ring tone.

At 1317, the system may connect the call.

At 1319, the on-screen display may remain off.

At 1321, the system may display a call length timer in the speakerphone display 405.

At 1323, the user may conduct the voice call.

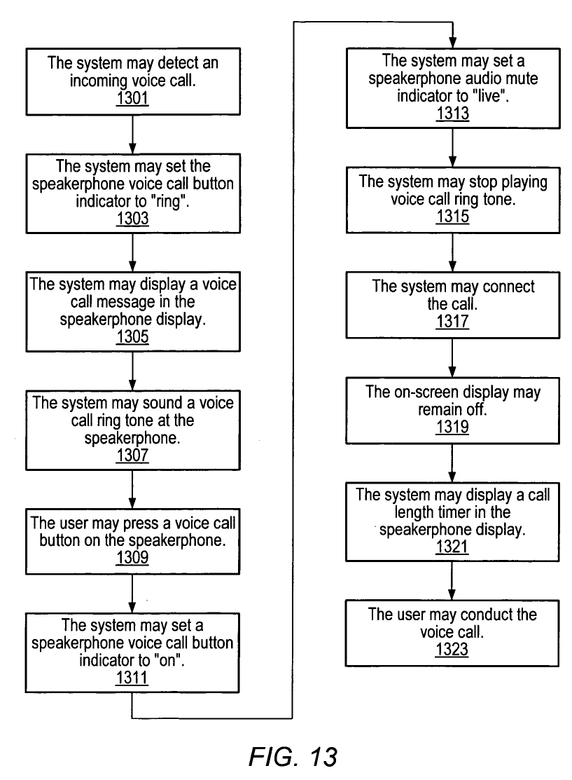

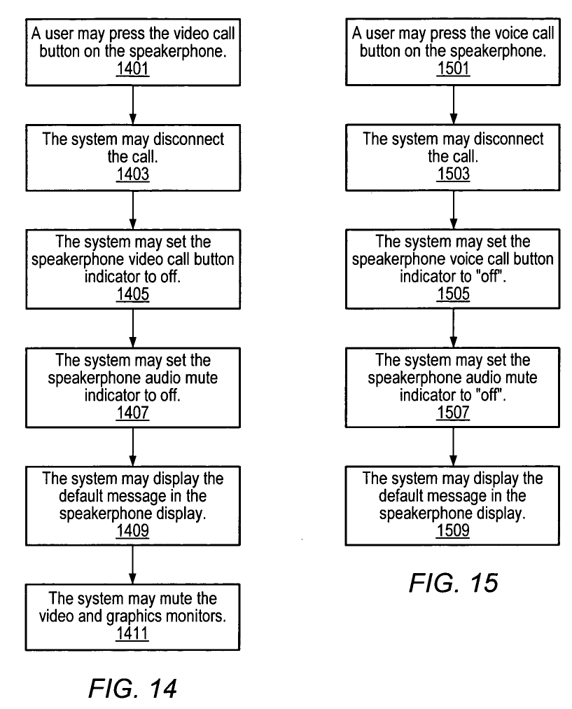

FIG. 14 illustrates a method for terminating the video call from the speakerphone, according to an embodiment. It is noted that in various embodiments one or more of the method elements may be performed concurrently, in a different order, or be omitted. Additional elements may be performed as desired.

At 1401, a user may press the video call button on the speakerphone.

At 1403, the system may disconnect the call.

At 1405, the system may set speakerphone video call button indicator to “off”.

At 1407, the system may set speakerphone audio mute indicator to “off”.

At 1409, the system may display the default message in the speakerphone display 405.

At 1411, the system may mute the video monitor.

FIG. 15 illustrates a method for terminating the current voice call from the speakerphone, according to an embodiment. It is noted that in various embodiments one or more of the method elements may be performed concurrently, in a different order, or be omitted. Additional elements may be performed as desired.

At 1501, a user may press the voice call button 409 on the speakerphone.

At 1503, the system may disconnect the call.

At 1505, the system may set the speakerphone voice call button indicator to “off”.

At 1507, the system may set the speakerphone audio mute indicator to “off”.

At 1509, the system may display the default message in the speakerphone display 405.

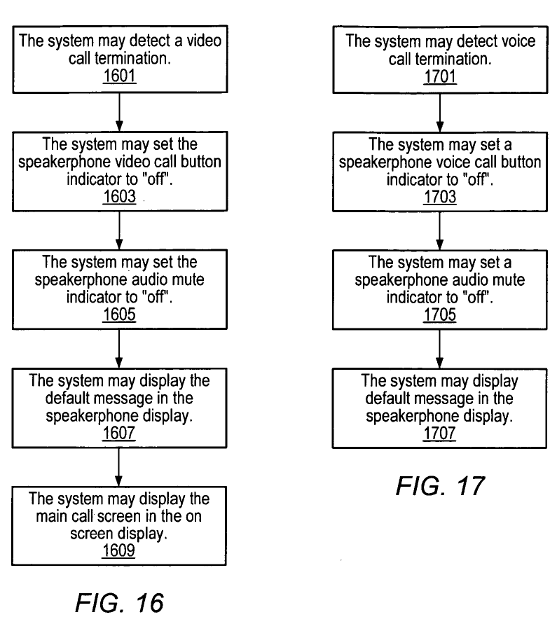

FIG. 16 illustrates a method for video call termination, according to an embodiment. It is noted that in various embodiments one or more of the method elements may be performed concurrently, in a different order, or be omitted. Additional elements may be performed as desired.

At 1601, the system may detect a video call termination.

At 1603, the system may set the speakerphone video call button indicator to “off”.

At 1605, the system may set the speakerphone audio mute indicator to “off”.

At 1607, the system may display the default message in the speakerphone display 405.

At 1609, the system may display the main call screen in the on screen display.

FIG. 17 illustrates a method for voice call termination, according to an embodiment. It is noted that in various embodiments one or more of the method elements may be performed concurrently, in a different order, or be omitted. Additional elements may be performed as desired.

At 1701, the system may detect voice call termination.

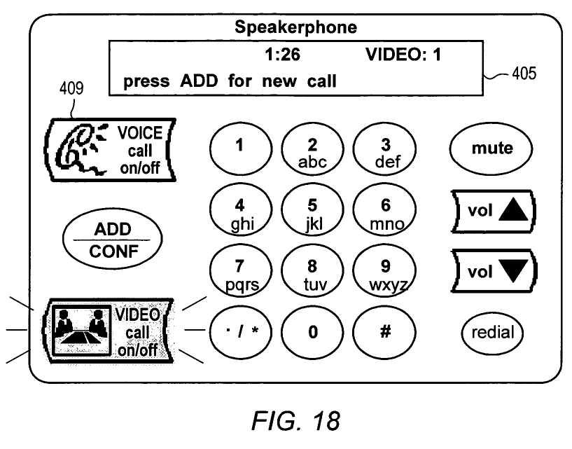

At 1703, the system may set a speakerphone voice call button indicator to “off”. For example, a light behind the speakerphone voice call button 409 may be turned off. In some embodiments, as seen in FIG. 18, an indicator may be changed or removed from the speakerphone display 405.

At 1705, the system may set a speakerphone audio mute indicator to “off”.

At 1707, the system may display a default message indicating no active call in the speakerphone display 405.

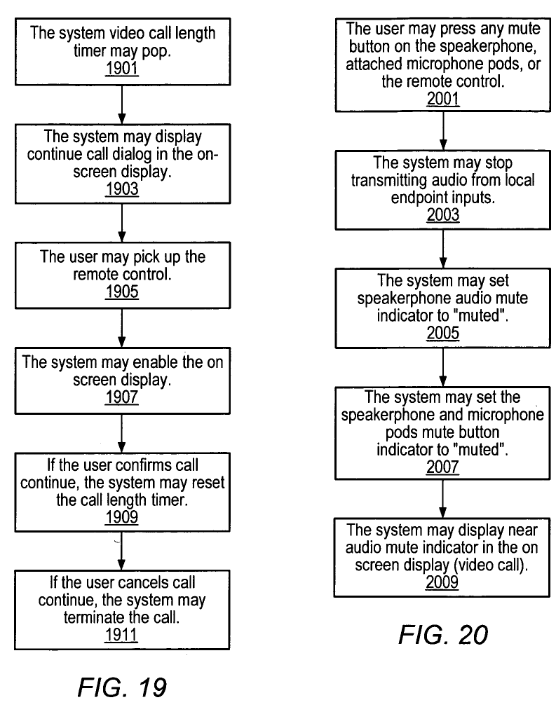

FIG. 19 illustrates a method for popping a video call length timer, according to an embodiment. It is noted that in various embodiments one or more of the method elements may be performed concurrently, in a different order, or be omitted. Additional elements may be performed as desired.

At 1901, the system video call length timer may pop. For example, the call length time may pop after a call length time of approximately 8 hours. The call length timer may be used to terminate a call if a user forgets to hang up the call.

At 1903, the system may display continue call dialog in the on-screen display.

At 1905, the user may pick up the remote control 501.

At 1907, the system may enable the on screen display.

At 1909, if the user confirms call continue, the system may reset the call length timer.

At 1911, if the user cancels call continue, the system may terminate the call.

FIG. 20 illustrates a method for muting audio of the current call, according to an embodiment. It is noted that in various embodiments one or more of the method elements may be performed concurrently, in a different order, or be omitted. Additional elements may be performed as desired.

At 2001, the user may press any mute button (e.g., the mute button 413 on the speakerphone, attached to the microphone pods, or the mute button 503 on the remote control 501).

At 2003, the system may stop transmitting audio from local endpoint inputs.

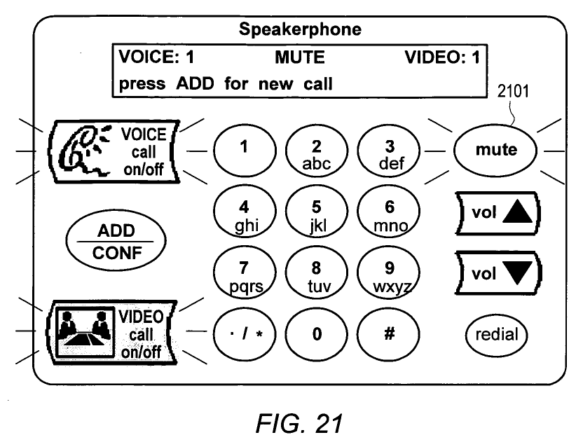

At 2005, the system may set speakerphone audio mute indicator to “muted”. For example, as shown in FIG. 21, the muted button 2101 may be illuminated.

At 2007, the system may set the speakerphone and microphone pods mute button indicator to “muted”.

At 2009, the system may display near audio mute indicator in the on screen display (video call).

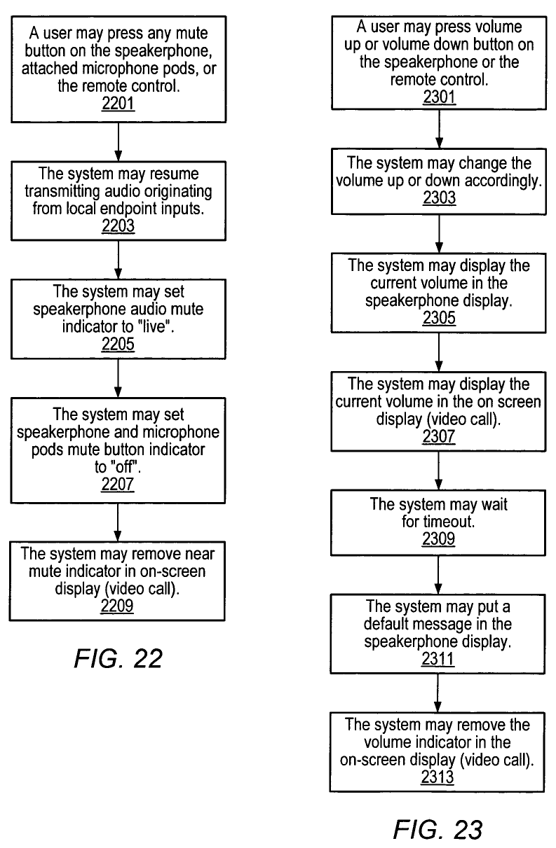

FIG. 22 illustrates a method for un-muting the current call, according to an embodiment. It is noted that in various embodiments one or more of the method elements may be performed concurrently, in a different order, or be omitted. Additional elements may be performed as desired.

At 2201, a user may press any mute button on the speakerphone, attached microphone pods, or the remote control 501.

At 2203, the system may resume transmitting audio originating from local endpoint inputs.

At 2205, the system may set speakerphone audio mute indicator to “live”.

At 2207, the system may set speakerphone and microphone pods mute button indicator to “off”.

At 2209, the system may remove near mute indicator in on-screen display (video call).

FIG. 23 illustrates a method for changing the volume of the current call, according to an embodiment. It is noted that in various embodiments one or more of the method elements may be performed concurrently, in a different order, or be omitted. Additional elements may be performed as desired.

At 2301, a user may press a volume up 315 or volume down button 317 on the speakerphone or the remote control (volume up 505, volume down 507).

At 2303, the system may increase or decrease the volume accordingly.

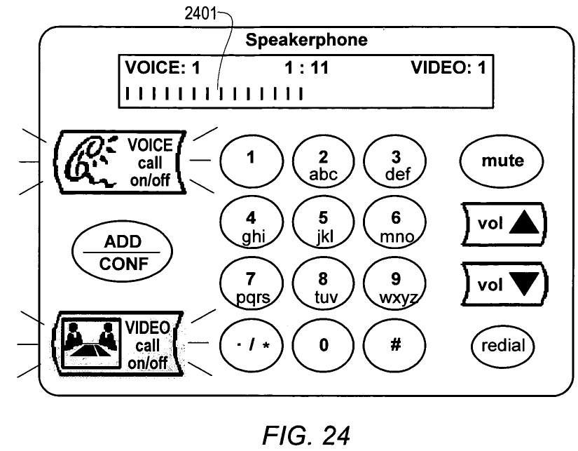

At 2305, the system may display the current volume in the speakerphone display 405. For example, as seen in FIG. 24, lines 2401 may be used to indicate the volume level.

At 2307, the system may display the current volume in the on screen display (video call).

At 2309, the system may wait for timeout.

At 2311, the system may put a default message, indicating the timeout, in the speakerphone display 405.

At 2313, the system may remove the volume indicator in the on-screen display (video call).

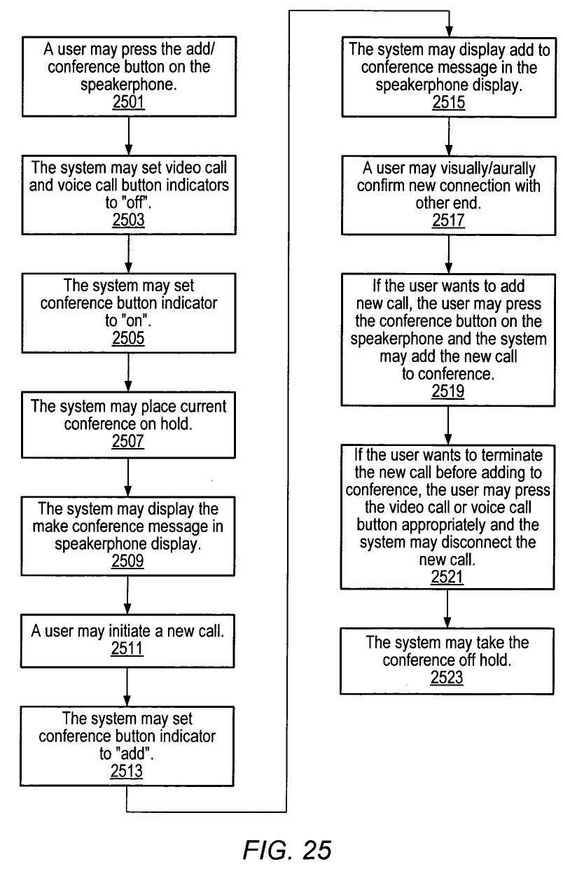

FIG. 25 illustrates a method for adding other callers to conference from the speakerphone, according to an embodiment. It is noted that in various embodiments one or more of the method elements may be performed concurrently, in a different order, or be omitted. Additional elements may be performed as desired.

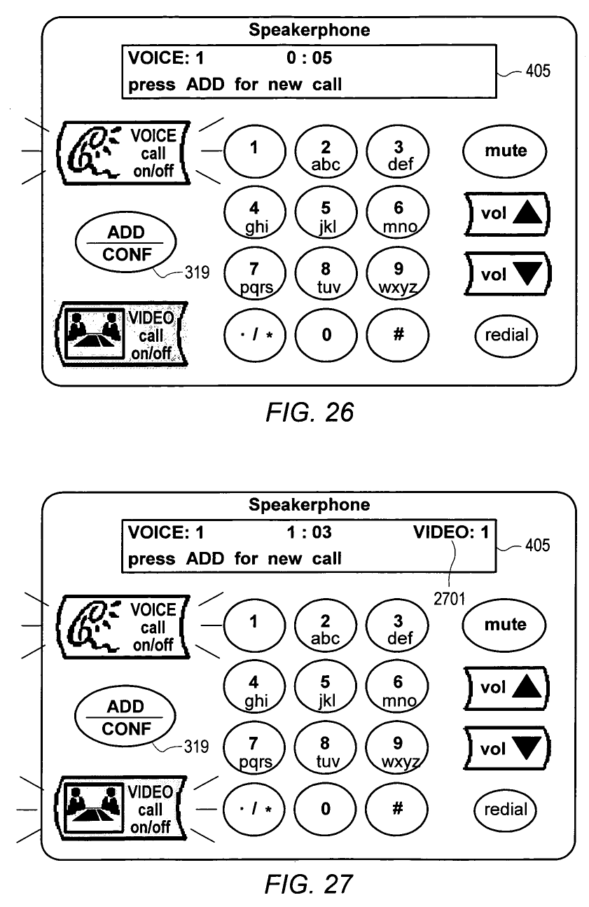

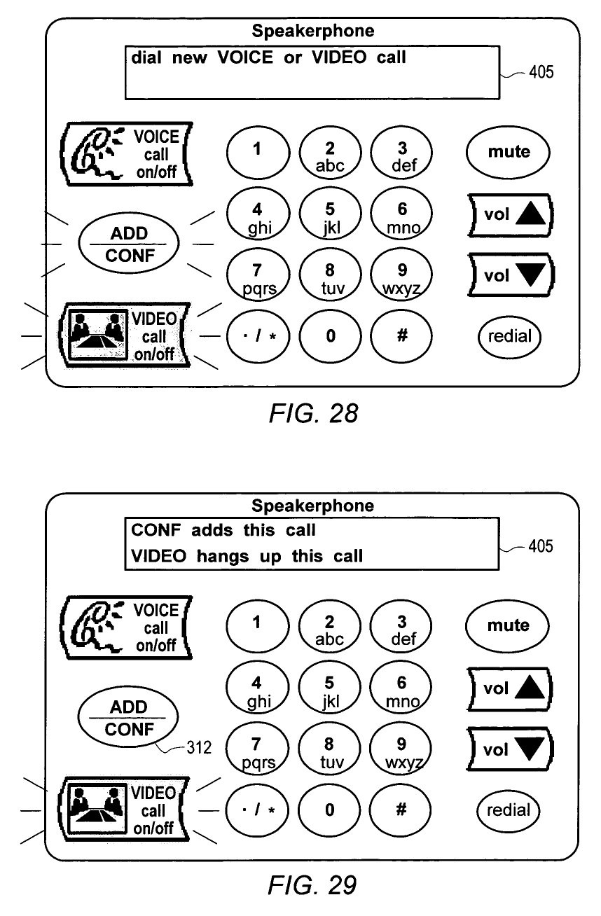

At 2501, a user may press the add/conference button 319 on the speakerphone. The add/conference button 319 may be pressed during a voice only call (as seen in FIG. 26), a video only call (as seen in FIG. 29), or a voice and video call (as seen in FIG. 27). The add/conference button 319 may act as a “flash hook” (i.e., similar to a flash-hook paradigm when a phone hook was pressed to flash hook when adding a new caller. As seen in FIG. 28, the user may then be instructed to dial the new number for the video or voice call.

At 2503, the system may set video call and voice call button indicators to “off”.

At 2505, the system may set conference button indicator to “on”.

At 2507, the system may place current conference on hold. In some embodiments, the current conference participants may continue with the conference.

At 2509, the system may display the make conference message in speakerphone display 405. For example, as seen in FIG. 29, the user may be instructed to press the voice or video button to start the corresponding type of call. The user may hear a new dial tone.

At 2511, a user may initiate a new call. When the new participant connects, the user may have an isolated consult (i.e., isolated from the other conference).

At 2513, the system may set conference button indicator to “add”. For example, an add portion of the conference button 319 may be illuminated.

At 2515, the system may display add to conference message in the speakerphone display 405.

At 2517, a user may visually/aurally confirm a new connection with the other end of the call. For example, as seen in FIG. 29, the display may instruct the user to press the add/conference button 312 to add the call to the conference or press the video button to hang up the current call.

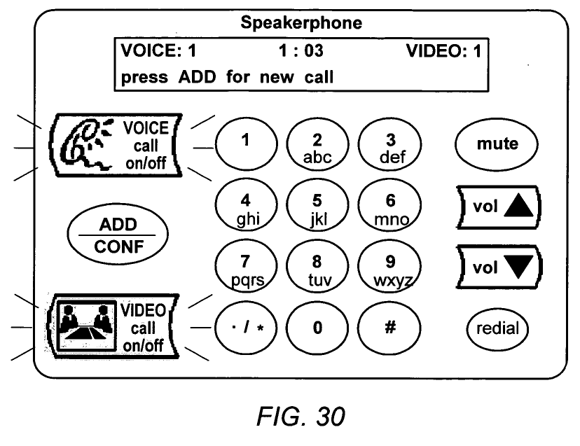

At 2519, if the user wants to add a new call, the user may press the conference button 319 on the speakerphone and the system may add the new call to conference. For example, if the user is on a voice call and adds a video call, the resulting screen may show both a voice and video call connected to the conference (as seen in FIG. 30).

At 2521, if the user wants to terminate the new call before adding to the conference, the user may press the video call 407 or voice call button 409 appropriately and the system may disconnect the new call.

At 2523, the system may take the conference off hold.

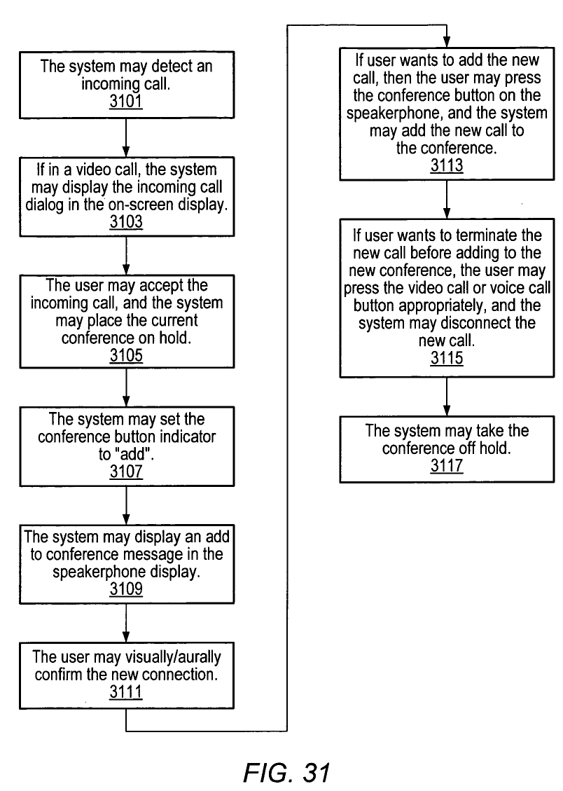

FIG. 31 illustrates a method for accepting incoming callers to conference from the speakerphone, according to an embodiment. It is noted that in various embodiments one or more of the method elements may be performed concurrently, in a different order, or be omitted. Additional elements may be performed as desired.

At 3101, the system may detect an incoming call.

At 3103, if in a video call, the system may display the incoming call dialog in the on-screen display.

At 3105, the user may accept the incoming call, and the system may place the current conference on hold.

At 3107, the system may set the conference button indicator to “add”.

At 3109, the system may display an add to conference message in the speakerphone display 405.

At 3111, the user may visually/aurally confirm the new connection.

At 3113, if user wants to add the new call, then the user may press the conference button 319 on the speakerphone, and the system may add the new call to the conference.

At 3115, if the user wants to terminate the new call before adding to the new conference, the user may press the video call 407 or voice call button 409 appropriately, and the system may disconnect the new call.

At 3117, the system may take the conference off hold.

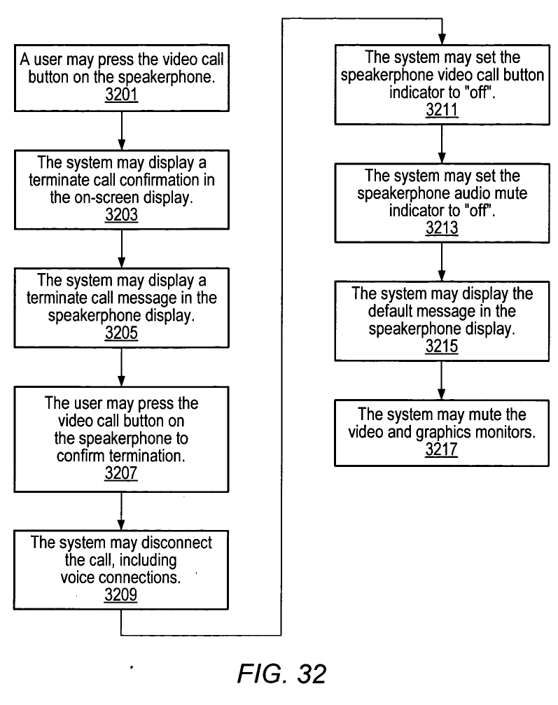

FIG. 32 illustrates a method for terminating multipoint video call from the speakerphone, according to an embodiment. It is noted that in various embodiments one or more of the method elements may be performed concurrently, in a different order, or be omitted. Additional elements may be performed as desired.

At 3201, a user may press the video call button on the speakerphone.

At 3203, the system may display a terminate call confirmation in the on-screen display.

At 3205, the system may display a terminate call message in the speakerphone display 405.

At 3207, the user may press the video call button 407 on the speakerphone to confirm termination.

At 3209, the system may disconnect the call, including voice connections.

At 3211, the system may set the speakerphone video call button indicator to “off”.

At 3213, the system may set the speakerphone audio mute indicator to “off”.

At 3215, the system may display the default message in the speakerphone display 405.

At 3217, the system may mute the video monitor.

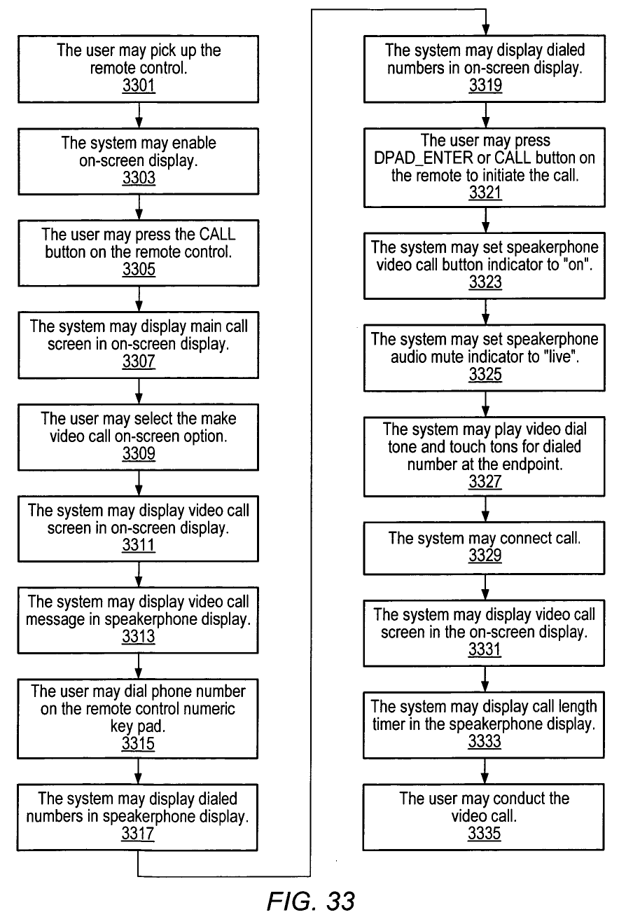

FIG. 33 illustrates a method for placing a video call with the remote control, according to an embodiment. It is noted that in various embodiments one or more of the method elements may be performed concurrently, in a different order, or be omitted. Additional elements may be performed as desired.

At 3301, the user may pick up the remote control.

At 3303, the system may enable on-screen display.

At 3305, the user may press the CALL button on the remote control.

At 3307, the system may display main call screen in on-screen display.

At 3309, the user may select the make video call on-screen option.

At 3311, the system may display video call screen in on-screen display.

At 3313, the system may display video call message in speakerphone display.

At 3315, the user may dial phone number on the remote control numeric keypad.

At 3317, the system may display dialed numbers in speakerphone display.

At 3319, the system may display dialed numbers in on-screen display.

At 3321, the user may press DPAD_ENTER or CALL button on the remote to initiate the call.

At 3323, the system may set speakerphone video call button indicator to “on”.

At 3325, the system may set speakerphone audio mute indicator to “live”.

At 3327, the system may play video dial tone and touch tons for dialed number at the endpoint.

At 3329, the system may connect call.

At 3331, the system may display video call screen in the on-screen display.

At 3333, the system may display call length timer in the speakerphone display At 3335, the user may conduct the video call.

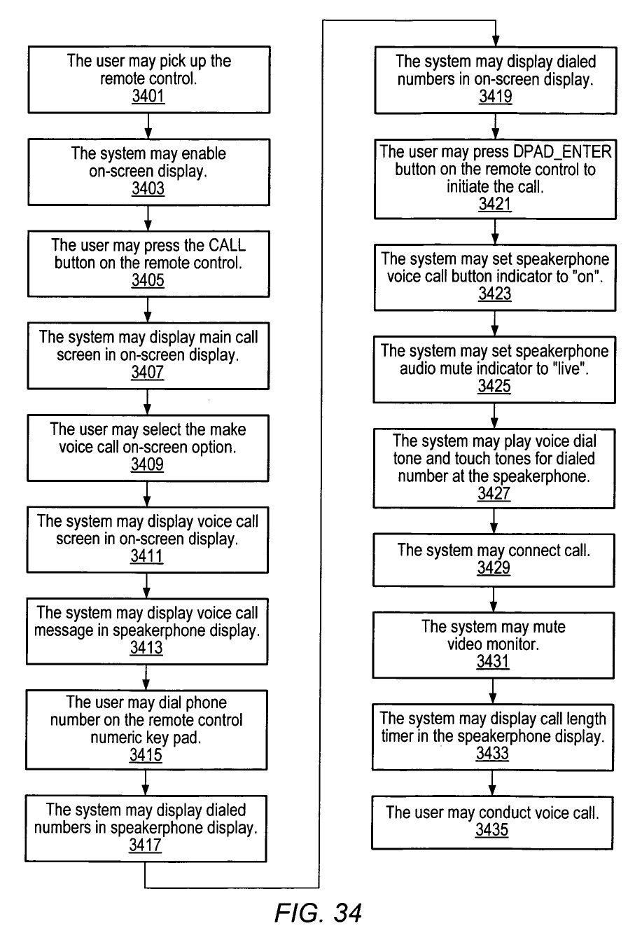

FIG. 34 illustrates a method for placing a voice call with the remote control, according to an embodiment. It is noted that in various embodiments one or more of the method elements may be performed concurrently, in a different order, or be omitted. Additional elements may be performed as desired.

At 3401, the user may pick up the remote control.

At 3403, the system may enable on-screen display.

At 3405, the user may press the CALL button on the remote control.

At 3407, the system may display main call screen in on-screen display.

At 3409, the user may select the make voice call on-screen option.

At 3411, the system may display voice call screen in on-screen display.

At 3413, the system may display voice call message in speakerphone display.

At 3415, the user may dial phone number on the remote control numeric keypad.

At 3417, the system may display dialed numbers in speakerphone display.

At 3419, the system may display dialed numbers in on-screen display.

At 3421, the user may press DPAD_ENTER button on the remote control to initiate the call.

At 3423, the system may set speakerphone voice call button indicator to “on”.

At 3425, the system may set speakerphone audio mute indicator to “live”.

At 3427, the system may play voice dial tone and touch tones for dialed number at the speakerphone.

At 3429, the system may connect call.

At 3431, the system may mute video monitor.

At 3433, the system may display call length timer in the speakerphone display.

At 3435, the user may conduct voice call.

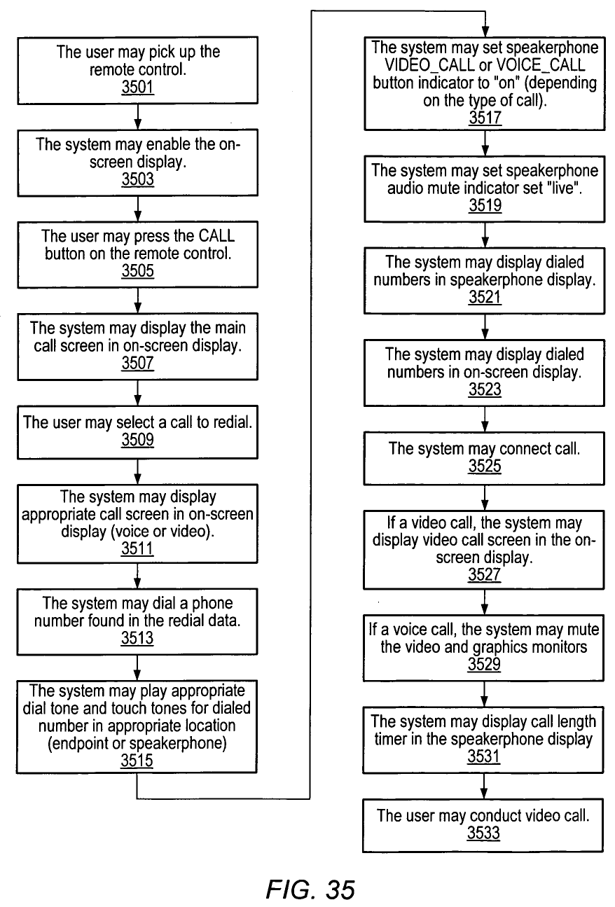

FIG. 35 illustrates a method for redialing last call(s) with the remote control, according to an embodiment. It is noted that in various embodiments one or more of the method elements may be performed concurrently, in a different order, or be omitted. Additional elements may be performed as desired.

At 3501, the user may pick up the remote control.

At 3503, the system may enable the on-screen display.

At 3505, the user may press the CALL button on the remote control.

At 3507, the system may display the main call screen in on-screen display.

At 3509, the user may select a call to redial.

At 3511, the system may display appropriate call screen in on-screen display (voice or video).

At 3513, the system may dial a phone number found in the redial data.

At 3515, the system may play appropriate dial tone and touch tones for dialed number in appropriate location (endpoint or speakerphone) At 3517, the system may set speakerphone VIDEO_CALL or VOICE_CALL button indicator to “on” (depending on the type of call).

At 3519, the system may set speakerphone audio mute indicator set “live”.

At 3521, the system may display dialed numbers in speakerphone display.

At 3523, the system may display dialed numbers in on-screen display.

At 3525, the system may connect call.

At 3527, if a video call, the system may display video call screen in the on-screen display.

At 3529, if a voice call, the system may mute the video and graphics monitors At 3531, the system may display call length timer in the speakerphone display At 3533, the user may conduct video call.

FIG. 36 illustrates a method for accepting incoming video call with the remote control, according to an embodiment. It is noted that in various embodiments one or more of the method elements may be performed concurrently, in a different order, or be omitted. Additional elements may be performed as desired.

At 3601, the system may detect an incoming video call.

At 3603, the system may set speakerphone video call button indicator to “ring”.

At 3605, the system may display video call message in the speakerphone display.

At 3607, the system may display incoming call screen in the on-screen display.

At 3609, the system may play video call ring tone at the endpoint.

At 3611, the user may pick up the remote control.

At 3613, the system may enable the on-screen display.

At 3615, the user may press CALL or DPAD_ENTER button on the remote control.

At 3617, the system may set speakerphone VIDEO CALL button indicator to on”.

At 3619, the system may set speakerphone audio mute indicator to “live”.

At 3621, the system may stop playing video call ring tone.

At 3623, the system may connect the call.

At 3625, the system may display video call screen in the on-screen display.

At 3627, the system may display call length timer in the speakerphone display.

At 3629, the user may conduct video call.

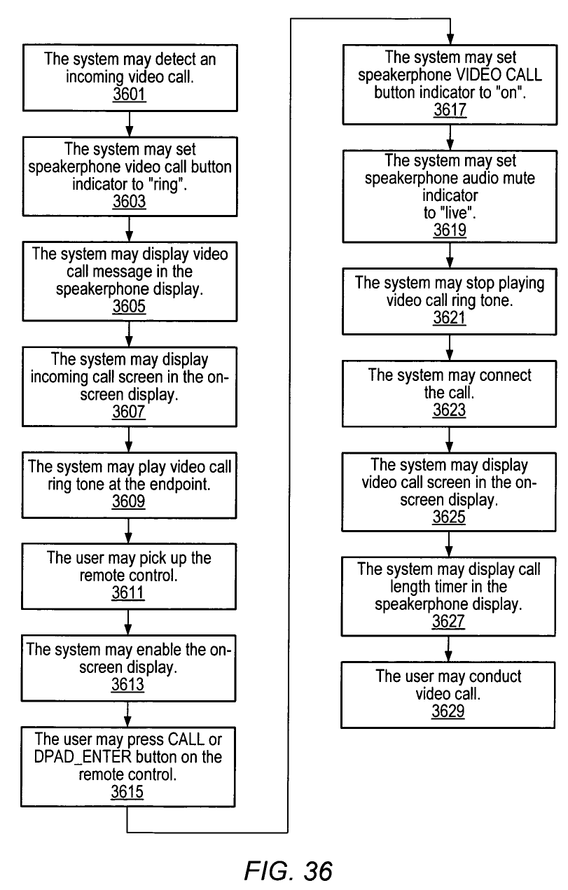

FIG. 37 illustrates a method for accepting incoming voice call with the remote control, according to an embodiment. It is noted that in various embodiments one or more of the method elements may be performed concurrently, in a different order, or be omitted. Additional elements may be performed as desired.

At 3701, the system may detect an incoming voice call.

At 3703, the system may set speakerphone voice call button indicator to “ring”.

At 3705, the system may display voice call message in the speakerphone display.

At 3707, the system may play voice call ring tone at the speakerphone.

At 3709, the user may pick up the remote control.

At 3711, the system may display incoming call screen in the on-screen display.

At 3713, the user may press CALL or DPAD_ENTER button on the remote control.

At 3715, the system may set speakerphone voice call button indicator to “on”.

At 3717, the system may set speakerphone audio mute indicator to “live”.

At 3719, the system may stop playing voice call ring tone.

At 3721, the system may connect call.

At 3723, the system may mute video monitor.

At 3725, the system may display call length timer in the speakerphone display.

At 3727, the user may conduct voice call.

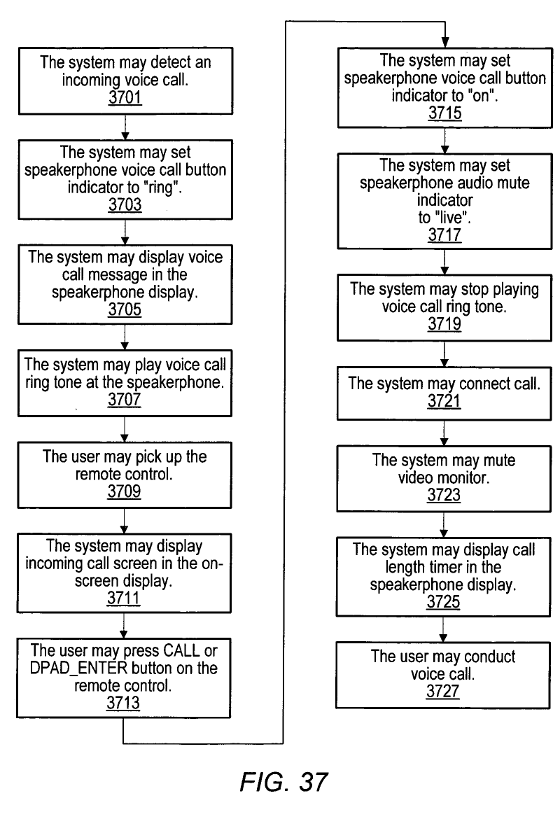

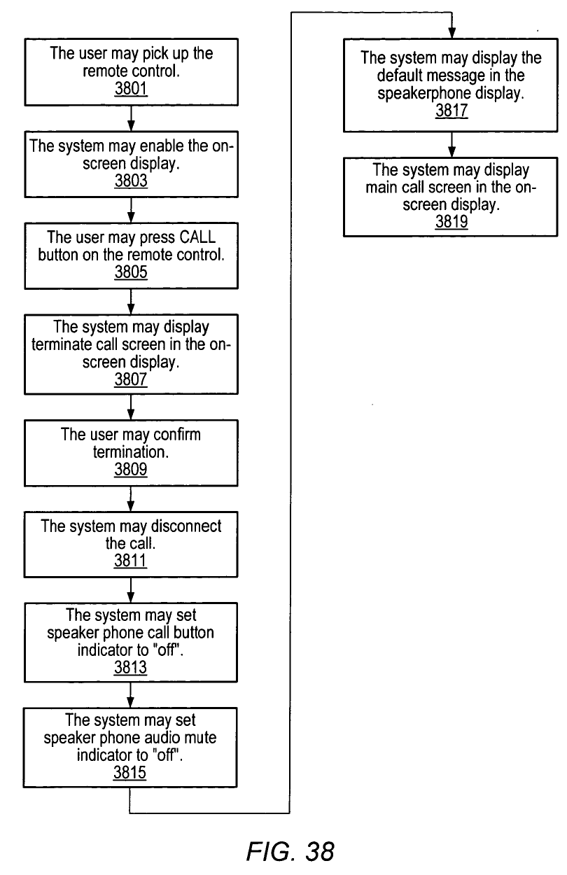

FIG. 38 illustrates a method for terminating the current call with the remote control, according to an embodiment. It is noted that in various embodiments one or more of the method elements may be performed concurrently, in a different order, or be omitted. Additional elements may be performed as desired.

At 3801, the user may pick up the remote control.

At 3803, the system may enable the on-screen display.

At 3805, the user may press CALL button on the remote control.

At 3807, the system may display terminate call screen in the on-screen display.

At 3809, the user may confirm termination.

At 3811, the system may disconnect the call.

At 3813, the system may set speakerphone call button indicator to “off”.

At 3815, the system may set speakerphone audio mute indicator to “off”.

At 3817, the system may display the default message in the speakerphone display.

At 3819, the system may display main call screen in the on-screen display.

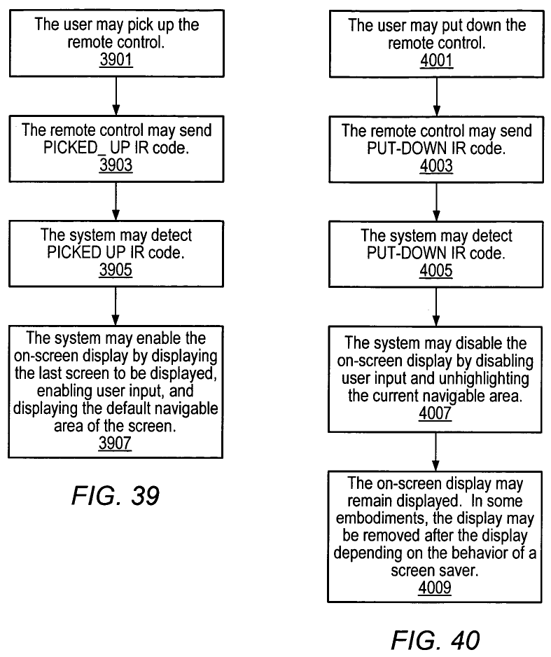

FIG. 39 illustrates a method for picking up the remote control, according to an embodiment. It is noted that in various embodiments one or more of the method elements may be performed concurrently, in a different order, or be omitted. Additional elements may be performed as desired.

At 3901, the user may pick up the remote control.

At 3903, the remote control may send PICKED_UP IR code.

At 3905, the system may detect PICKED UP IR code.

At 3907, the system may enable the on-screen display by displaying the last screen to be displayed, enabling user input, and displaying the default navigable area of the screen.

FIG. 40 illustrates a method for putting down the remote control, according to an embodiment. It is noted that in various embodiments one or more of the method elements may be performed concurrently, in a different order, or be omitted. Additional elements may be performed as desired.

At 4001, the user may put down the remote control.

At 4003, the remote control may send PUT-DOWN IR code (i.e., a signal that indicates the remote control has been placed on a surface).

At 4005, the system may detect PUT-DOWN IR code.

At 4007, the system may disable the on-screen display by disabling user input and unhighlighting the current navigable area.

At 4009, the on-screen display may remain displayed. In some embodiments, the display may be removed after the display depending on the behavior of a screen saver.

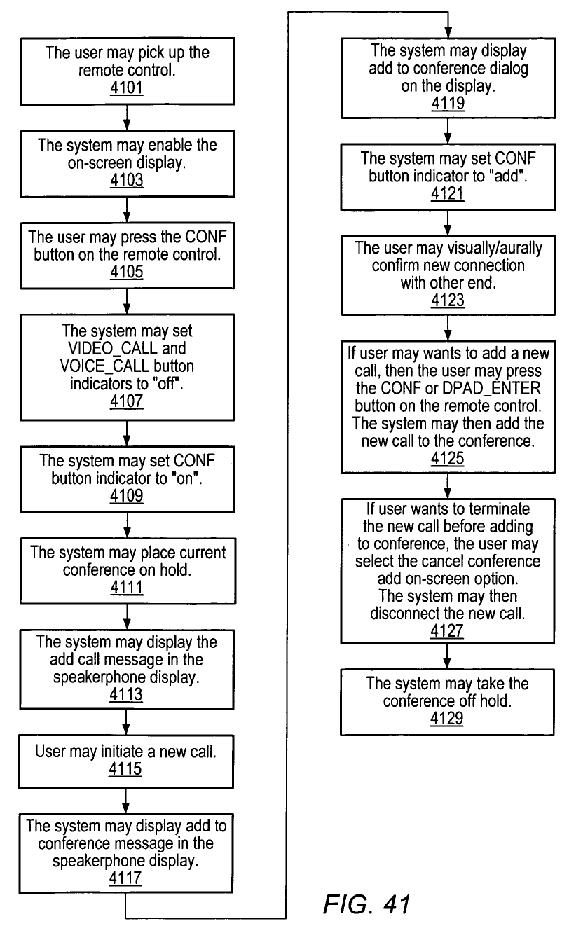

FIG. 41 illustrates a method for adding another caller to the conference with the remote control, according to an embodiment. It is noted that in various embodiments one or more of the method elements may be performed concurrently, in a different order, or be omitted. Additional elements may be performed as desired.

At 4101, the user may pick up the remote control.

At 4103, the system may enable the on-screen display.

At 4105, the user may press the CONF button on the remote control.

At 4107, the system may set VIDEO_CALL and VOICE_CALL button indicators to “off”.

At 4109, the system may set CONF button indicator to “on”.

At 4111, the system may place current conference on hold.

At 4113, the system may display the add call message in the speakerphone display.

At 4115, user may initiate a new call.

At 4117, the system may display add to conference message in the speakerphone display.

At 4119, the system may display add to conference dialog on-screen the display.

At 4121, the system may set CONF button indicator to “add”.

At 4123, the user may visually/aurally confirm new connection with other end.

At 4125, if user may wants to add a new call, then the user may press the CONF or DPAD_ENTER button on the remote control. The system may then add the new call to the conference.

At 4127, if user wants to terminate the new call before adding to conference, the user may select the cancel conference add on-screen option. The system may then disconnect the new call.

At 4129, the system may take the conference off hold.

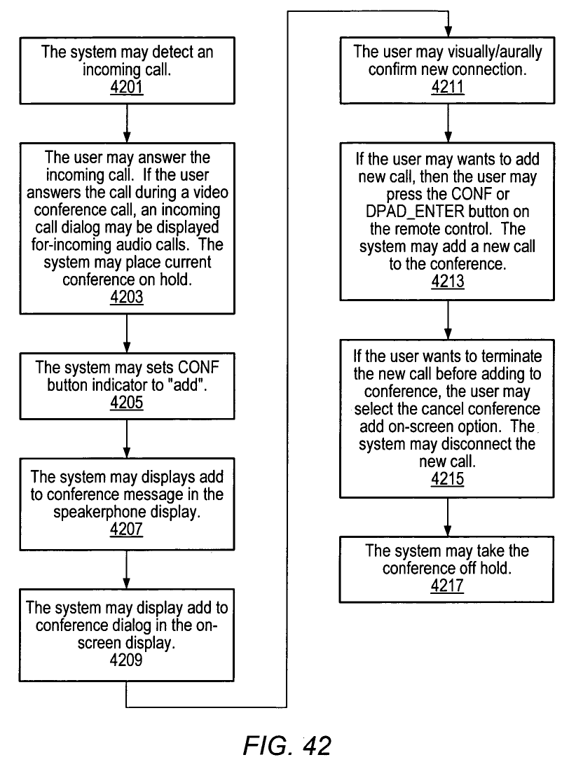

FIG. 42 illustrates a method for accepting an incoming caller to conference with the remote control, according to an embodiment. It is noted that in various embodiments one or more of the method elements may be performed concurrently, in a different order, or be omitted. Additional elements may be performed as desired.

At 4201, the system may detect an incoming call.

At 4203, the user may answer the incoming call. If the user answers the call during a video conference call, an incoming call dialog may be displayed for-incoming audio calls. The system may place current conference on hold.

At 4205, the system may set CONF button indicator to “add”.

At 4207, the system may display add to conference message in the speakerphone display.

At 4209, the system may display add to conference dialog in the on-screen display.

At 4211, the user may visually/aurally confirm new connection.

At 4213, if the user may wants to add new call, then the user may press the CONF or DPAD_ENTER button on the remote control. The system may add a new call to the conference.

At 4215, if the user wants to terminate the new call before adding to conference, the user may select the cancel conference add on-screen option. The system may disconnect the new call.

At 4217, the system may take the conference off hold.

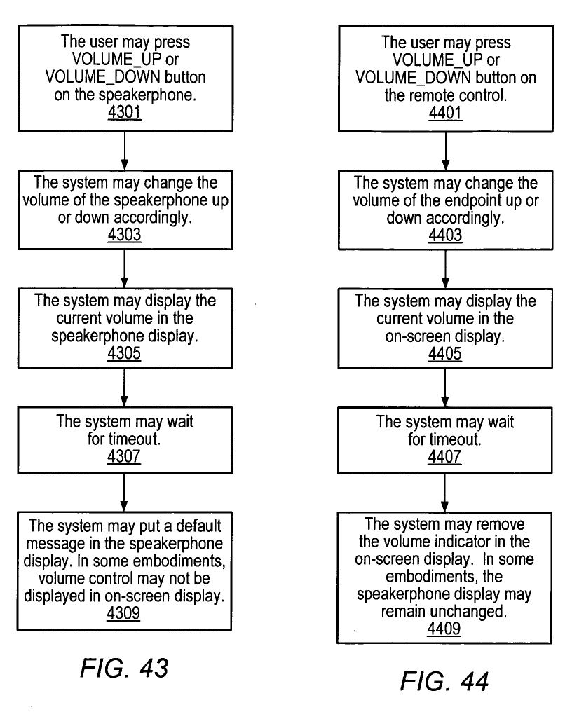

FIG. 43 illustrates a method for changing volume from a speakerphone during a video call with an added voice call, according to an embodiment. It is noted that in various embodiments one or more of the method elements may be performed concurrently, in a different order, or be omitted. Additional elements may be performed as desired.

At 4301, the user may press VOLUME_UP or VOLUME_DOWN button on the speakerphone.

At 4303, the system may change the volume of the speakerphone up or down accordingly.

At 4305, the system may display the current volume in the speakerphone display.

At 4307, the system may wait for timeout.

At 4309, the system may put default message in the speakerphone display. In some embodiments, volume control may not be displayed in on-screen display.

FIG. 44 illustrates a method for changing volume with remote control during a video call with an added voice call, according to an embodiment. It is noted that in various embodiments one or more of the method elements may be performed concurrently, in a different order, or be omitted. Additional elements may be performed as desired.

At 4401, the user may press VOLUME_UP or VOLUME_DOWN button on the remote control.

At 4403, the system may change the volume of the endpoint up or down accordingly.

At 4405, the system may display the current volume in the on-screen display.

At 4407, the system may wait for timeout.

At 4409, the system may remove the volume indicator in the on-screen display. In some embodiments, the speakerphone display may remain unchanged.

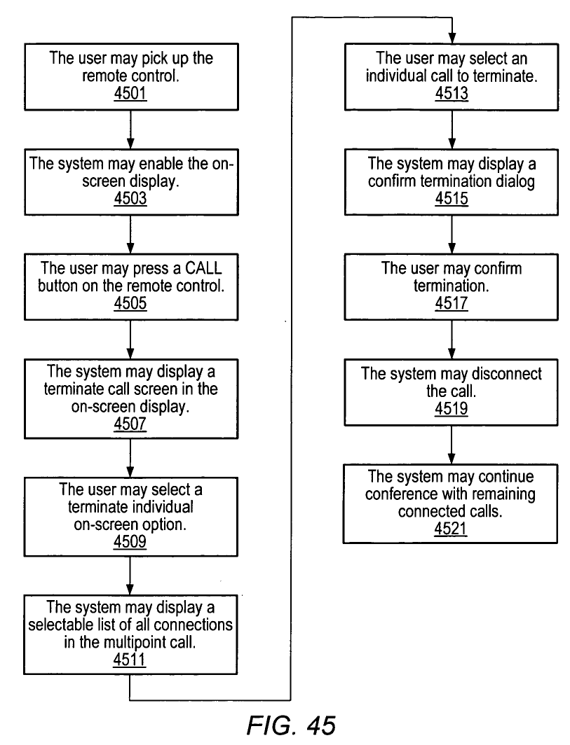

FIG. 45 illustrates a method for terminating an individual connection in a multipoint call, according to an embodiment. It is noted that in various embodiments one or more of the method elements may be performed concurrently, in a different order, or be omitted. Additional elements may be performed as desired.

At 4501, the user may pick up the remote control.

At 4503, the system may enable the on-screen display.

At 4505, the user may press a CALL button on the remote control.

At 4507, the system may display a terminate call screen in the on-screen display.

At 4509, the user may select a terminate individual on-screen option.

At 4511, the system may display a selectable list of all connections in the multipoint call.

At 4513, the user may select an individual call to terminate.

At 4515, the system may display a confirm termination dialog

At 4517, the user may confirm termination.

At 4519, the system may disconnect the call.

At 4521, the system may continue conference with remaining connected calls.

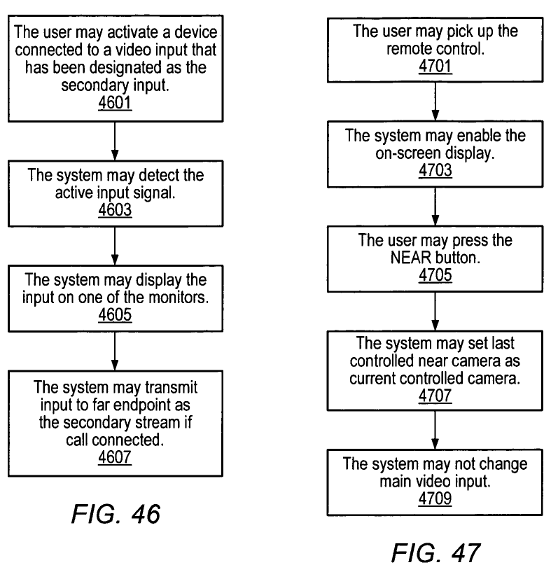

FIG. 46 illustrates a method for activating a secondary input, according to an embodiment. It is noted that in various embodiments one or more of the method elements may be performed concurrently, in a different order, or be omitted. Additional elements may be performed as desired.

At 4601, the user may activate a device connected to a video input that has been designated as the secondary input.

At 4603, the system may detect the active input signal.

At 4605, the system may display the input on one of the monitors.

At 4607, the system may transmit input to far endpoint as the secondary stream if call connected.

FIG. 47 illustrates a method for selecting a near camera for control, according to an embodiment. It is noted that in various embodiments one or more of the method elements may be performed concurrently, in a different order, or be omitted. Additional elements may be performed as desired.

At 4701, the user may pick up the remote control.

At 4703, the system may enable the on-screen display.

At 4705, the user may press the NEAR button.

At 4707, the system may set last controlled near camera as current controlled camera.

At 4709, the system may not change main video input.

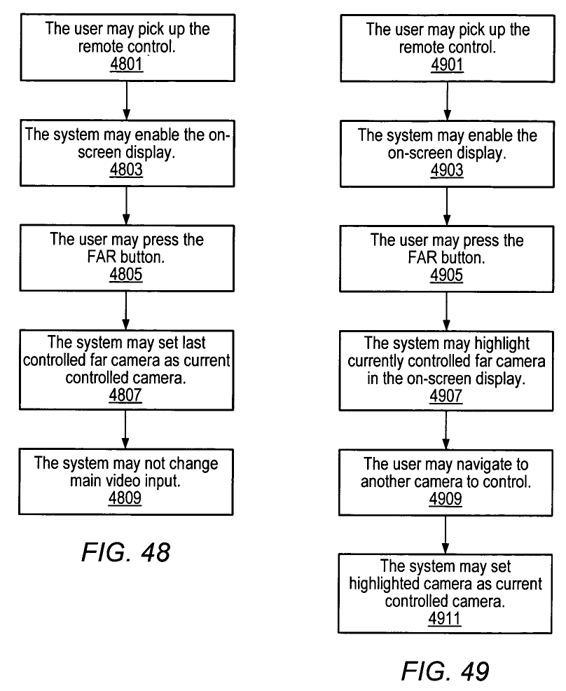

FIG. 48 illustrates a method for selecting a far camera for control, according to an embodiment. It is noted that in various embodiments one or more of the method elements may be performed concurrently, in a different order, or be omitted. Additional elements may be performed as desired.

At 4801, the user may pick up the remote control.

At 4803, the system may enable the on-screen display.

At 4805, the user may press the FAR button.

At 4807, the system may set last controlled far camera as current controlled camera.

At 4809, the system may not change main video input.

FIG. 49 illustrates a method for selecting a new camera for control during continuous presence, according to an embodiment. It is noted that in various embodiments one or more of the method elements may be performed concurrently, in a different order, or be omitted. Additional elements may be performed as desired.

At 4901, the user may pick up the remote control.

At 4903, the system may enable the on-screen display.

At 4905, the user may press the FAR button.

At 4907, the system may highlight currently controlled far camera in the on-screen display.

At 4909, the user may navigate to another camera to control.

At 4911, the system may set highlighted camera as current controlled camera.

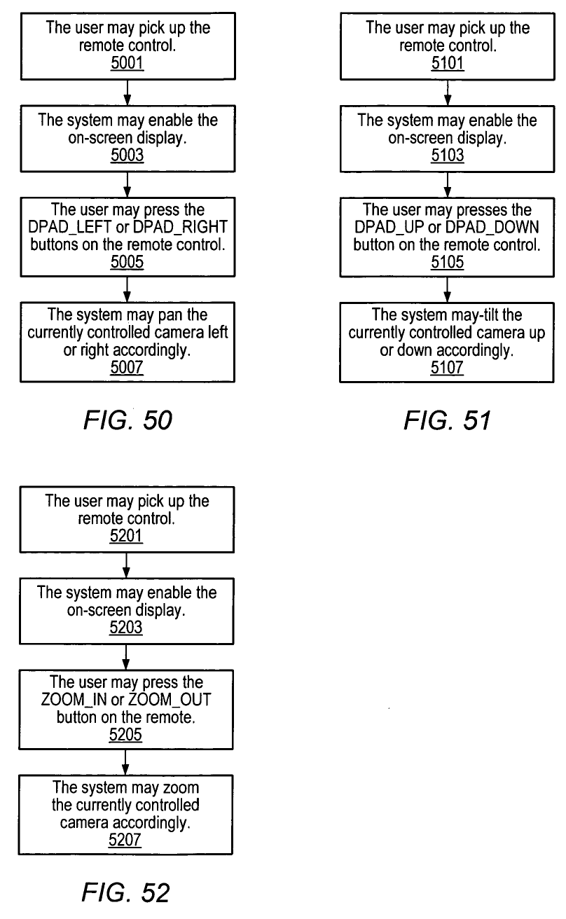

FIG. 50 illustrates a method for panning a camera, according to an embodiment. It is noted that in various embodiments one or more of the method elements may be performed concurrently, in a different order, or be omitted. Additional elements may be performed as desired.

At 5001, the user may pick up the remote control.

At 5003, the system may enable the on-screen display.

At 5005, the user may press the DPAD_LEFT or DPAD_RIGHT buttons on the remote control.

At 5007, the system may pan the currently controlled camera left or right accordingly.

FIG. 51 illustrates a method for tilting a camera, according to an embodiment. It is noted that in various embodiments one or more of the method elements may be performed concurrently, in a different order, or be omitted. Additional elements may be performed as desired.

At 5101, the user may pick up the remote control.

At 5103, the system may enable the on-screen display.

At 5105, the user may presses the DPAD_UP or DPAD_DOWN button on the remote control.

At 5107, the system may-tilt the currently controlled camera up or down accordingly.

FIG. 52 illustrates a method for zooming a camera, according to an embodiment. It is noted that in various embodiments one or more of the method elements may be performed concurrently, in a different order, or be omitted. Additional elements may be performed as desired.

At 5201, the user may pick up the remote control.

At 5203, the system may enable the on-screen display.

At 5205, the user may press the ZOOM_IN or ZOOM_OUT button on the remote.

At 5207, the system may zoom the currently controlled camera accordingly.

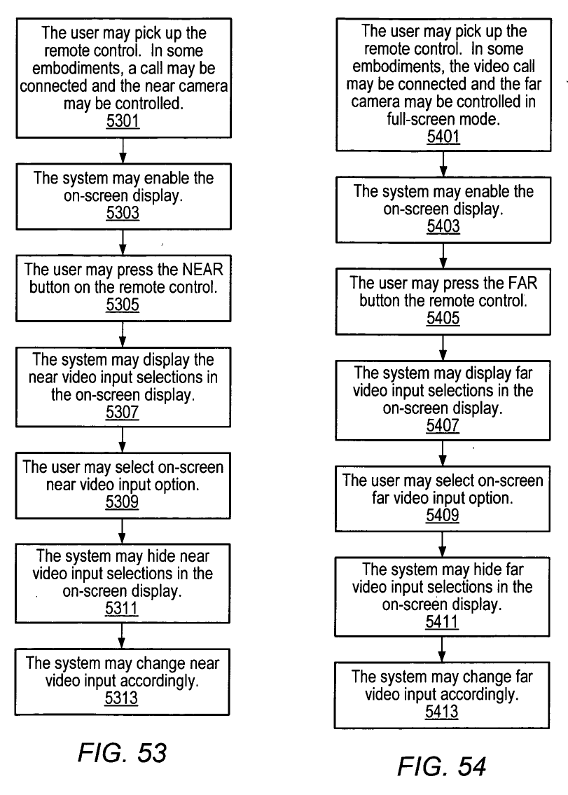

FIG. 53 illustrates a method for selecting near video input, according to an embodiment. It is noted that in various embodiments one or more of the method elements may be performed concurrently, in a different order, or be omitted. Additional elements may be performed as desired.

At 5301, the user may pick up the remote control. In some embodiments, a call may be connected and the near camera may be controlled.

At 5303, the system may enable the on-screen display.

At 5305, the user may press the NEAR button on the remote control

At 5307, the system may display the near video input selections in the on screen display.

At 5309, the user may select on-screen near video input option.

At 5311, the system may hide near video input selections in the on-screen display.

At 5313, the system may change near video input accordingly.

FIG. 54 illustrates a method for selecting a far video input, according to an embodiment. It is noted that in various embodiments one or more of the method elements may be performed concurrently, in a different order, or be omitted. Additional elements may be performed as desired.

At 5401, the user may pick up the remote control. In some embodiments, the video call may be connected and the far camera may be controlled in full-screen mode.

At 5403, the system may enable the on-screen display.

At 5405, the user may press the FAR button the remote control.

At 5407, the system may display far video input selections in the on-screen display.

At 5409, the user may select on-screen far video input option.

At 5411, the system may hide far video input selections in the on-screen display.

At 5413, the system may change far video input accordingly.

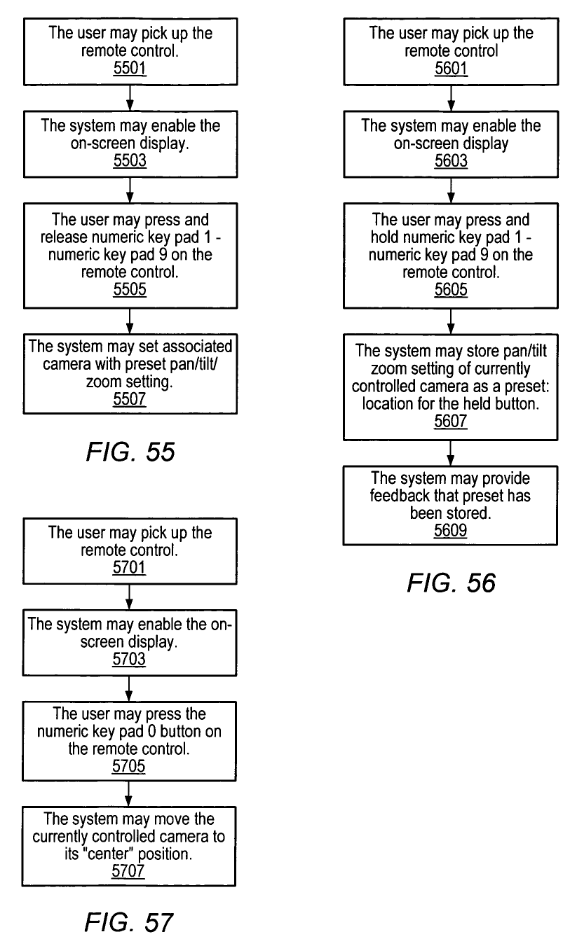

FIG. 55 illustrates a method for moving a camera to a preset position with the remote control, according to an embodiment. It is noted that in various embodiments one or more of the method elements may be performed concurrently, in a different order, or be omitted. Additional elements may be performed as desired.

At 5501, the user may pick up the remote control.

At 5503, the system may enable the on-screen display.

At 5505, the user may press and release numeric keypad 1—numeric keypad 9 on the remote control.

At 5507, the system may set associated camera with preset pan/tilt/zoom setting.

FIG. 56 illustrates a method for setting the camera position preset with the remote control, according to an embodiment. It is noted that in various embodiments one or more of the method elements may be performed concurrently, in a different order, or be omitted. Additional elements may be performed as desired.

At 5601, the user may pick up the remote control.

At 5603, the system may enable the on-screen display.

At 5605, the user may press and hold numeric keypad 1—numeric keypad 9 on the remote control.

At 5607, the system may store pan/tilt zoom setting of currently controlled camera as a preset location for the held button.

At 5609, the system may provide feedback that preset has been stored.

FIG. 57 illustrates a method for centering a camera with remote control, according to an embodiment. It is noted that in various embodiments one or more of the method elements may be performed concurrently, in a different order, or be omitted. Additional elements may be performed as desired.

At 5701, the user may pick up the remote control.

At 5703, the system may enable the on-screen display.

At 5705, the user may press the numeric keypad 0 button on the remote control.

At 5707, the system may move the currently controlled camera to its “center” position.

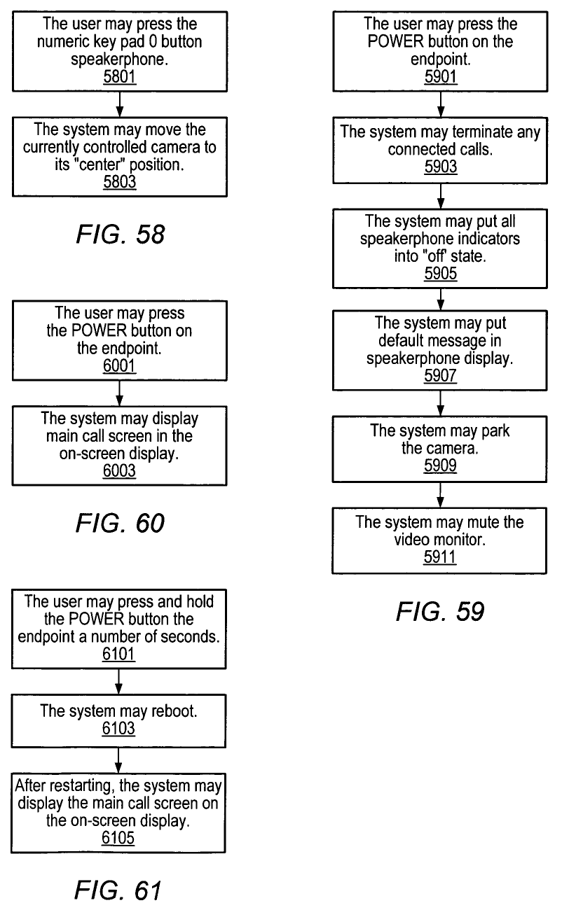

FIG. 58 illustrates a method for centering a camera with a speakerphone, according to an embodiment. It is noted that in various embodiments one or more of the method elements may be performed concurrently, in a different order, or be omitted. Additional elements may be performed as desired.

At 5801, the user may press the numeric keypad 0 button speakerphone.

At 5803, the system may move the currently controlled camera to its “center” position.

FIG. 59 illustrates a method for manually suspending the system, according to an embodiment. It is noted that in various embodiments one or more of the method elements may be performed concurrently, in a different order, or be omitted. Additional elements may be performed as desired.

At 5901, the user may press the POWER button on the endpoint.

At 5903, the system may terminate any connected calls.

At 5905, the system may put all speakerphone indicators into “off state.

At 5907, the system may put default message in speakerphone display.

At 5909, the system may park the camera.

At 5911, the system may mute the video monitor.

FIG. 60 illustrates a method for manually resuming the system, according to an embodiment. It is noted that in various embodiments one or more of the method elements may be performed concurrently, in a different order, or be omitted. Additional elements may be performed as desired.

At 6001, the user may press the POWER button on the endpoint.

At 6003, the system may display main call screen in the on-screen display.

FIG. 61 illustrates a method for restarting the system, according to an embodiment. It is noted that in various embodiments one or more of the method elements may be performed concurrently, in a different order, or be omitted. Additional elements may be performed as desired.

At 6101, the user may press and hold the POWER button the endpoint a number of seconds.

At 6103, the system may reboot.

At 6105, after restarting, the system may display the main call screen on the on-screen display.

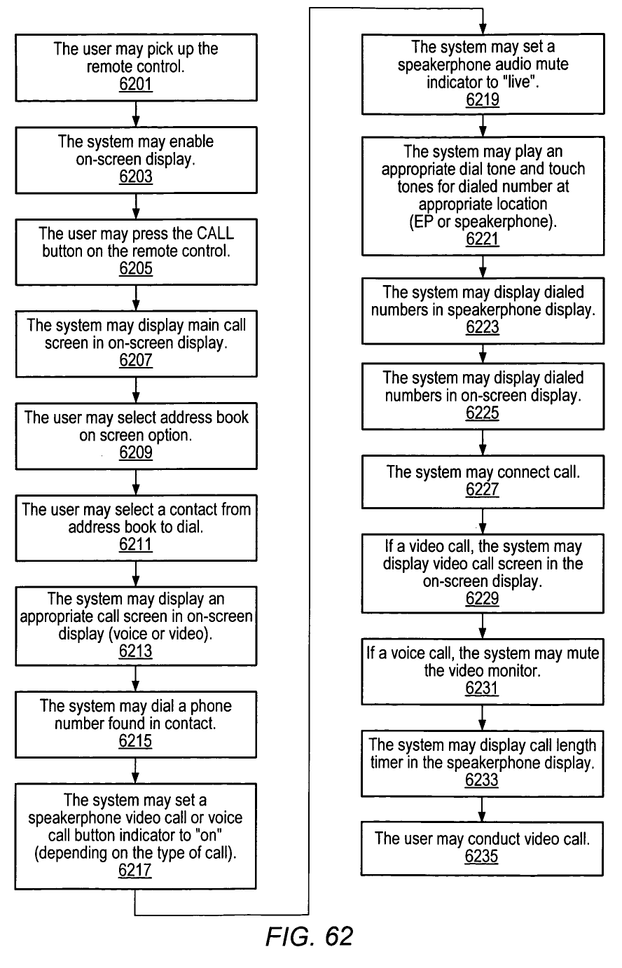

FIG. 62 illustrates a method for placing a call from an address book, according to an embodiment. It is noted that in various embodiments one or more of the method elements may be performed concurrently, in a different order, or be omitted. Additional elements may be performed as desired.

At 6201, the user may pick up the remote control.

At 6203, the system may enable on-screen display.

At 6205, the user may press the CALL button on the remote control.

At 6207, the system may display main call screen in on-screen display.

At 6209, the user may select address book on screen option.

At 6211, the user may select a contact from address book to dial.

At 6213, the system may display an appropriate call screen in on-screen display (voice or video).

At 6215, the system may dial a phone number found in contact.

At 6217, the system may set a speakerphone video call or voice call button indicator to “on” (depending on the type of call).

At 6219, the system may set a speakerphone audio mute indicator to “live”.

At 6221, the system may play an appropriate dial tone and touch tones for dialed number at appropriate location (EP or speakerphone).

At 6223, the system may display dialed numbers in speakerphone display.

At 6225, the system may display dialed numbers in on-screen display.

At 6227, the system may connect call.

At 6229, if a video call, the system may display video call screen in the on-screen display.

At 6231, if a voice call, the system may mute the video monitor.

At 6233, the system may display call length timer in the speakerphone display.

At 6235, the user may conduct video call.

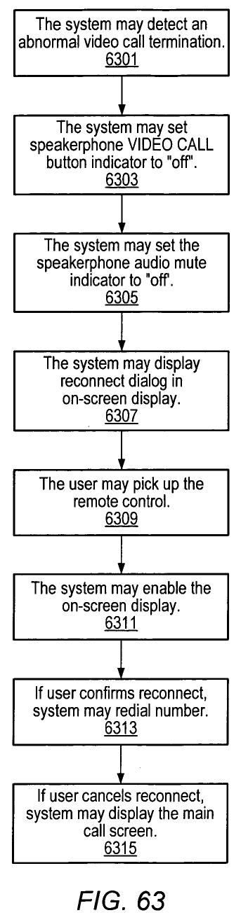

FIG. 63 illustrates a method for detecting abnormal video call termination, according to an embodiment. It is noted that in various embodiments one or more of the method elements may be performed concurrently, in a different order, or be omitted. Additional elements may be performed as desired.

At 6301, the system may detect an abnormal video call termination.

At 6303, the system may set speakerphone VIDEO CALL button indicator to “off”.

At 6305, the system may set the speakerphone audio mute indicator to “off”.

At 6307, the system may display reconnect dialog in on-screen display.

At 6309, the user may pick up the remote control.

At 6311, the system may enable the on-screen display.

At 6313, if user confirms reconnect, system may redial number.

At 6315, if user cancels reconnect, system may display the main call screen.

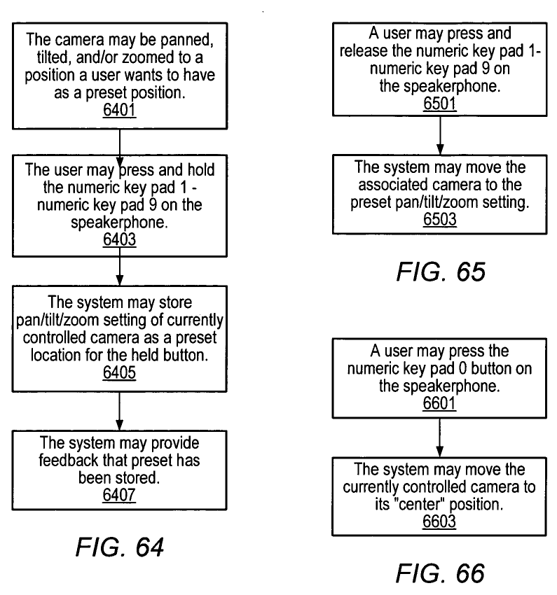

FIG. 64 illustrates a method for setting camera position preset with speakerphone, according to an embodiment. It is noted that in various embodiments one or more of the method elements may be performed concurrently, in a different order, or be omitted. Additional elements may be performed as desired.

At 6711, the camera may be panned, tilted, and/or zoomed to a position a user wants to have as a preset position.

At 6713, the user may press and hold the numeric keypad 1—numeric keypad 9 on the speakerphone. In some embodiments, instead of holding down a numeric keypad number, a separate button (not shown) may be pressed prior to pressing a numeric keypad number.

At 6715, the system may store pan/tilt/zoom setting of currently controlled camera as a preset location for the held button.

At 6717, the system may provide feedback that preset has been stored. For example, an audible signal may be given and the user may stop holding down the numeric keypad 1.

FIG. 65 illustrates a method for moving a camera to a preset position using the speakerphone, according to an embodiment. It is noted that in various embodiments one or more of the method elements may be performed concurrently, in a different order, or be omitted. Additional elements may be performed as desired.

At 6501, the user may press and release the numeric keypad 1—numeric keypad 9 on the speakerphone. In some embodiments, a camera move button (not shown) may be pressed prior to pressing the numeric keypad button to indicate the user wants to move the camera to a preset position.

At 6503, the system may move the associated camera to the preset pan/tilt/zoom setting.

FIG. 66 illustrates a method for centering camera with the speakerphone, according to an embodiment. It is noted that in various embodiments one or more of the method elements may be performed concurrently, in a different order, or be omitted. Additional elements may be performed as desired.

At 6601, a user may press the numeric keypad 0 button on the speakerphone. In some embodiments, a camera move button (not shown) may be pressed prior to pressing the numeric keypad 0 to indicate the user wants to move the camera.

At 6603, the system may move the currently controlled camera to its “center” position.

In various embodiments, other features may be incorporated into the speakerphone. For example, the speakerphone buttons may flash to suggest to a user which button to press next. In some embodiments, the button may be illuminated and then may slowly fade out. Other indicators to the user of which button to press next are also contemplated.

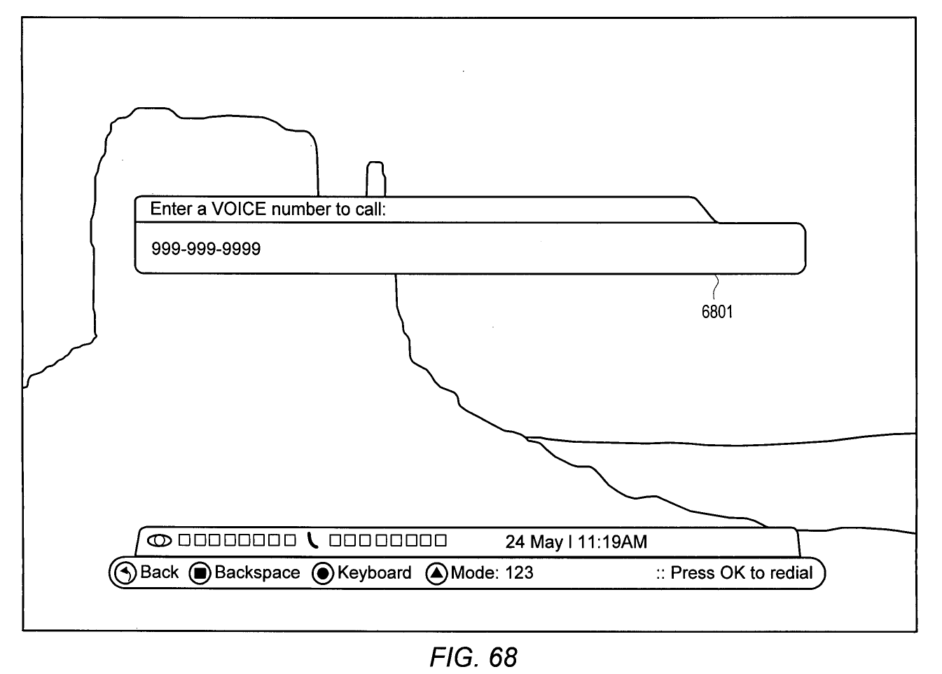

FIG. 67 illustrates a main video conferencing system screenshot, according to an embodiment. In some embodiments, a main screen may include an option to dial a video call 6701, dial a voice call 6703, access system information 6705, or access a directory 6707. In some embodiments, a list of past called/received numbers 6709 may be displayed to select for redialing. In some embodiments, various options on the main screen and described in FIGS. 68-76 may appear after a button is pushed on the remote control. In some embodiments, the remote control 501 may have different colored keys (e.g., green, blue, yellow, and red keys) and/or may have keys with different shapes. The colors and shapes of the keys may correspond to the shapes and colors on the screen. For example, button 517 on the remote may correspond to icon 6721 on screen. Similarly, buttons 513 and 511 may correspond to icons 6723 and 6725, respectively. In some embodiments, if a button is pressed, a short description of the button's function may be displayed. In some embodiments, an IP address 6711 may be shown for the system.

In some embodiments, the remote control may have sensors (e.g., capacitive sensors) that detect if the remote control has been lifted off of the table. A chip set on the remote control may auto calibrate the sensors to determine what type of surface the remote control has been placed on. In addition, there may be multiple sensors on the bottom of the remote control. This may be helpful in case the user picks up the remote and covers one of the sensors (the remote may know that the remote has not been placed on the table unless both sensors register a hard surface). When the remote is detected picked up, a video menu may be presented on the screen.

Embodiments of other functions that may be supported are listed in the following table:

| Name | Description |
|---|---|
| Admin Login | When an administrator logs in, this event |
| | notifies the Simple Network Management |
| | Protocol (SNMP) manager. |
| Admin Login Failed | When an attempt to log in as an |
| | administrator fails, this event notifies the |
| | SNMP manager. |
| Call Ended | When a call ends this notifies that SNMP |
| | manager |
| Call Failed | When a call fails, this notifies the SNMP |
| | manager of the reason |
| Call Started | When a call is made, this notifies the SNMP |
| | manager where it was made to |
| Software Upgrade | Allow the user to upgrade all the system |
| | software remotely |
| End Point Soft Power | Manual suspension/resumption of the |
| On/Off Switch | system |
| Screen Saver | Auto suspension of the system after idle time |
| | out |
| Load From File | Load new address book from file, overwrites |
| | existing |
| Merge From File | Merges new address book entries from a file |
| | with existing |
| Save To File | Save entire address book to file |
| Search Address Book | Allow the user to search the entries in the |
| | address book |
| View Address Book | Allow the user to view all the entries in the |
| | address book |
| Add Dialed Contact | Offers to add dialed contact if not found in |
| | address book |
| Delete Contact | Deletes a contact from the address book |
| Dial Contact | Dials a contact (single or multi-point) in the |
| | address book |
| Edit Contact | Edit a contact in the address book |
| New Contact | Add a new contact to the address book |
| Add Dialed Multipoint | Offers to add dialed multipoint call if not |
| Call | found in address book |
| Delete Multipoint | Delete a multi-point contact in the address |
| Contact | book |
| Dial Multipoint Contact | Dials a multi-point contact in the address |
| | book |
| Edit Multipoint Contact | Edit a multi-point contact in the address |
| | book |
| New Multipoint Contact | Add a new multi-point contact to the address |
| | book |
| Add Call | Conference a new video, voice, multipoint |
| | call into current call |
| Disconnect Call | Disconnects the current call |
| Do Not Disturb | Allow the viewer to place the end point into |
| | “Do Not Disturb” mode during the current |
| | call. Any incoming calls will not ring thru. |
| Maximum Time in a Call | Notify the user that the maximum time in a |
| | call has expired. Allow user to stay in call, or |
| | disconnect |
| Stay In Call | Stay in the currently connected call |
| Audio Mute | Mute/Unmute audio input on near end point |
| DVD/VCR Audio | Automatically attenuate the DVD/VCR audio |
| Input Attenuation | input when some speaks from any |
| | connected end point during call |
| Volume Control | Change the volume level up or down on the |
| | near end point |
| Control Far Camera | Allow user to control camera of far end point |
| Control Near Camera | Allow user to control camera of near end |
| | point |
| Pan/Tilt/Center/Zoom | Allow pan, tilt, center, and zoom of camera |
| | under control |
| Goto Preset | Moves the camera to a preset location (pan, |
| | tilt, and zoom) |
| Set Preset | Creates a preset |
| Incoming hang up | When a incoming call occurs during a |
| -vs- answer race | connected call, ensure that answering the |
| condition | incoming call (pressing the CALL buttons) |
| | does not hang up current call, when the |
| | incoming call hangs up first. |
| Terminate Single | Allow the user to terminate a singe video |
| Video Connection | connection in a multipoint call |
| Terminate Voice Add-in | Allow the user to terminate all voice add-in |
| | calls to a multipoint conference |
| Select Far Video Input | Allow the user to select the video input for |
| | the main video of the far end point |
| Select Near Video Input | Allow the user to select the video input for |
| | the main video of the near end point |
| Answer Incoming Call | Allows the user to accept an incoming video |
| | or audio call |
| Place Call by Address | Allow the user to dial a contact from the |
| Book | address book |
| Place Call by Redial List | Allow the user to radial a previously dialed |
| | contact |
| Place Video Call by | Allow the user to input a video phone |
| Number | number to dial |
| Place Voice Call by | Allow the user to input a voice phone |
| Number | number to dial |
| Audio Meter | Displays a meter showing level of audio |
| | input |
| Audio Tone Generator | Generates an audio tone for volume |
| | adjusting |
| Color Bar | Generates standard video color bars |
| Near End Loop | Provides audio/video loopback test of |
| | encoder and decoder |
| On-Screen Remote | An on-screen version of the remote control |
| | that provides the same function as the |
| | remote control itself. |
| Ping | Ping an IP address from the end point |
| Reset Address Book | Allows the user to reset address book |
| | settings back to factory defaults. |
| Reset System | Allows the user to reset custom settings in |
| | the end point back to factor defaults. |
| Restart System | Reboots end point |
| Send Message | Sends a text message to the end point |
| Remote Batter Low | When the remote has a low battery the |
| | SNMP manager is notified. |
| User in Need of | If the user has repeatedly asked for |
| Assistance | assistance, this event will notify the SNMP |
| | manager. |
| Chair Control | Allows a “director” of the conference call to |
| | ensure all connected parties see and hear |
| | the appropriate content |
| Stream Call | Streams the current call for viewing with a |
| | PC |
| Remove All Presets | Remove all presets |
| Close Captioning | Addition of close captioning text in real-time |
| | during a call. |
| Document placement | The EP should be able to detect when a user |
| under document | has placed a document under the document |
| camera detection | camera, indicating the input is now active |

FIG. 68 illustrates a screenshot of dialing a voice call, according to an embodiment. A voice number 6801 may appear as it is dialed. In some embodiments, the voice number may be entered through a speakerphone number pad and/or remote control.

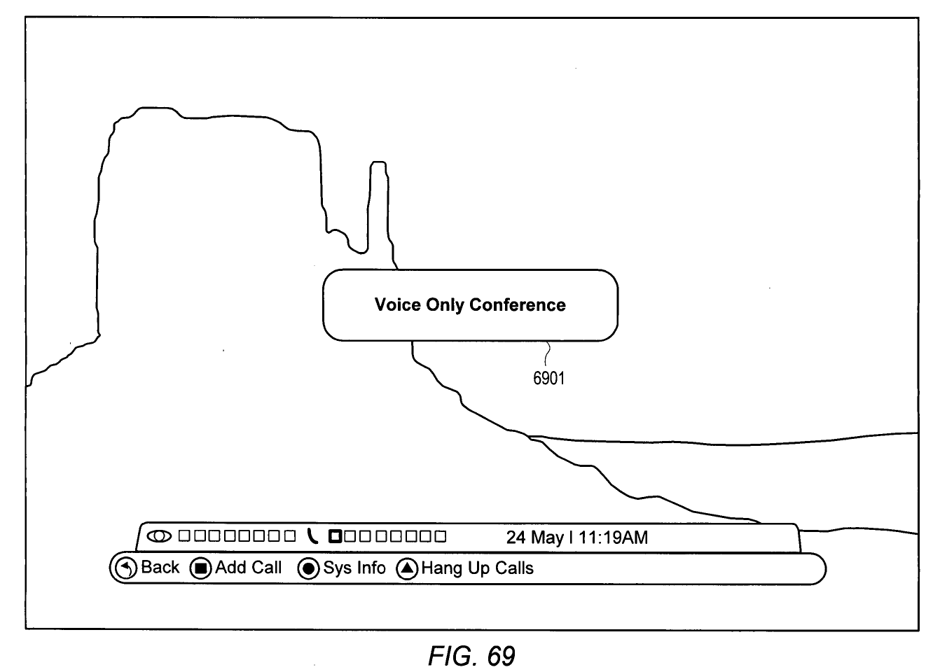

FIG. 69 illustrates a screenshot of a voice only conference call, according to an embodiment. In some embodiments, a “Voice Only Conference” message 6901 may be displayed if a voice only call (e.g., from a speakerphone) is received. Other messages are also contemplated.

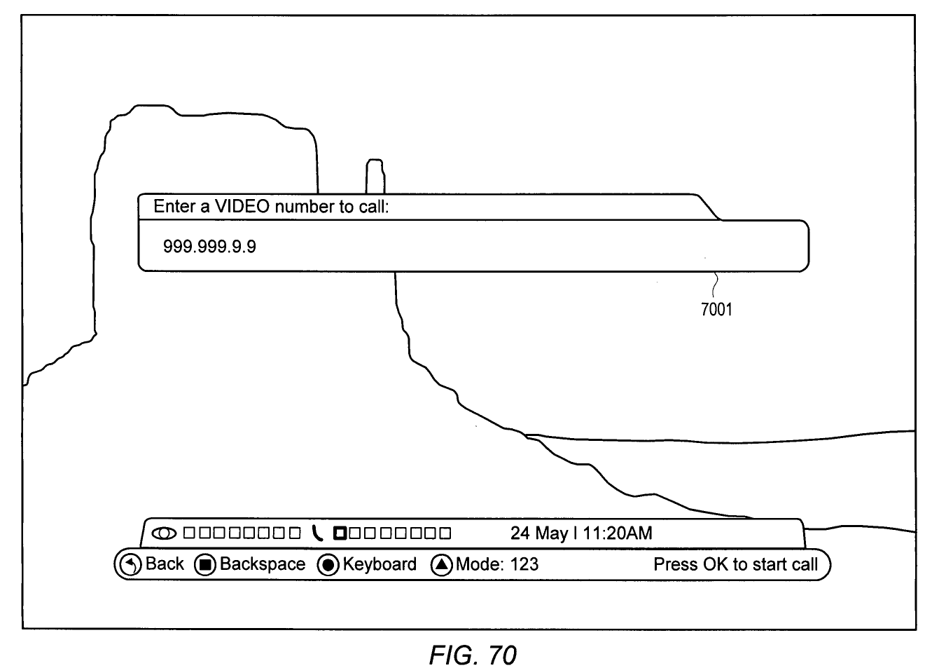

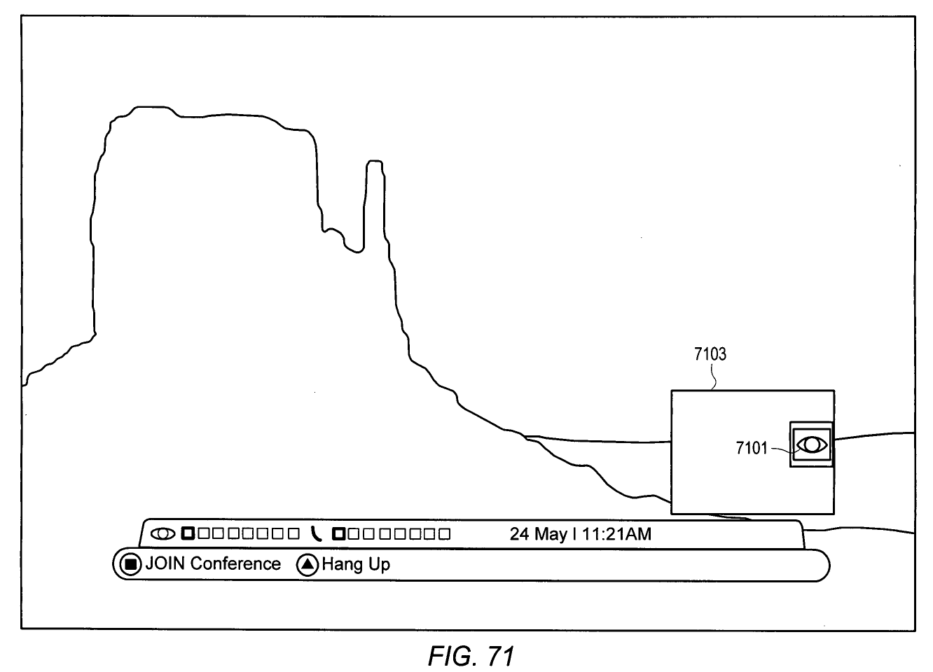

FIG. 70 illustrates a screenshot of adding a video call, according to an embodiment. A video number 7001 may appear as it is dialed. In some embodiments, the video number may be entered through a speakerphone number pad and/or remote control. FIG. 71 illustrates a screenshot of a video/voice call and/or consulting a video caller, according to an embodiment. In some embodiments, a default screen may be displayed while a video and/or voice call is occurring. This may include side consultations calls that may be kept separate from the main conference call. In some embodiments, an icon 7101 may be used to indicate on the screen which camera is being used. For example, if the conference system is using multiple cameras, the icon's placement relative to an on-screen box 7103 may indicate a relative location of the camera being used relative to the on-screen picture. Other shapes and icons may also be used.

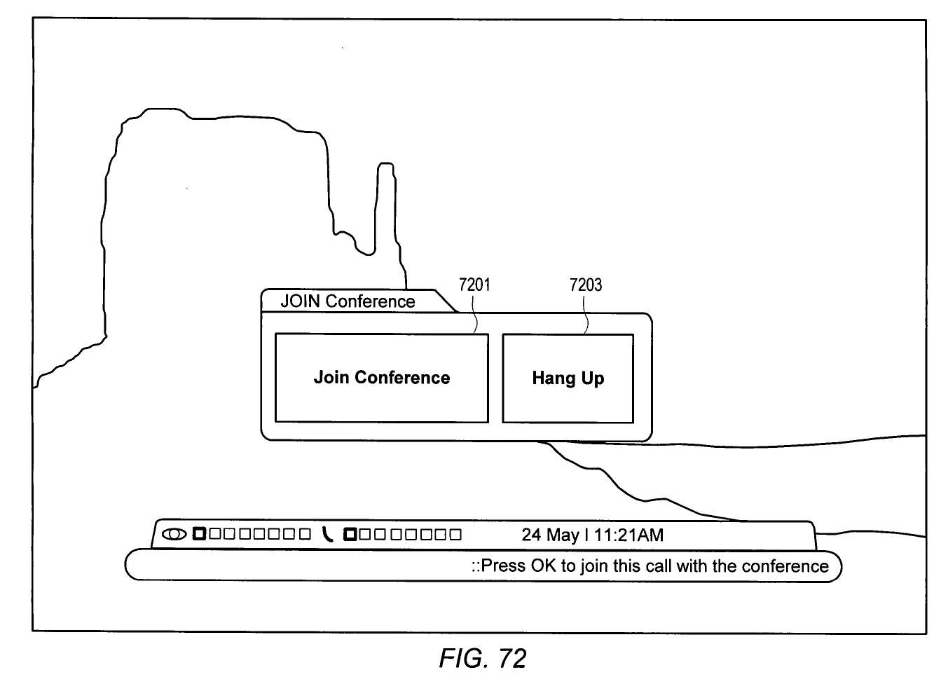

FIG. 72 illustrates a screenshot of joining a conference call, according to an embodiment. In some embodiments, after a call is made, an option may appear on the screen to join the call to the conference 7201 or to hang up the call 7203 after the call is concluded.

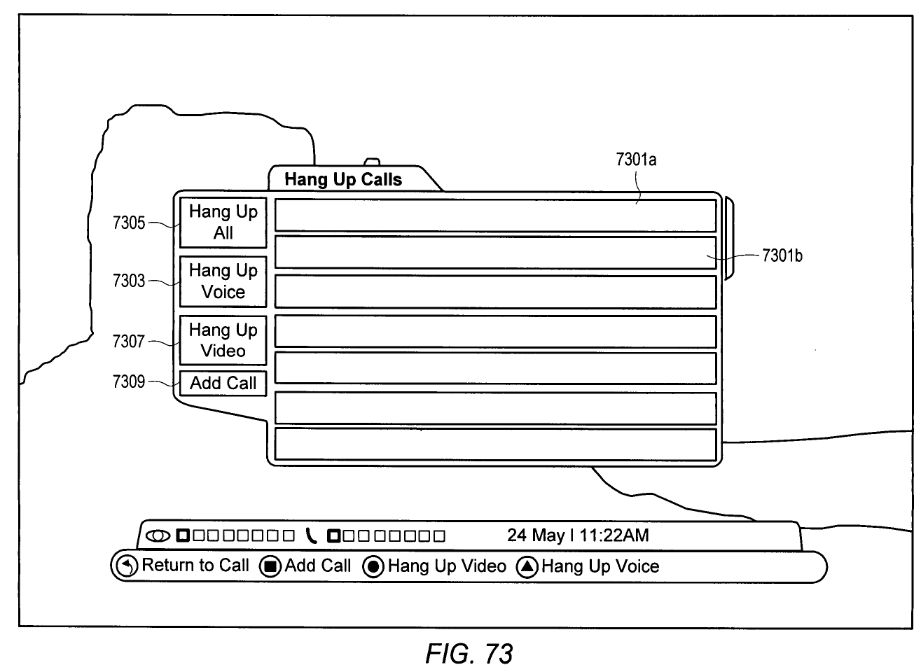

FIG. 73 illustrates a screenshot of hanging up a video/voice call, according to an embodiment. In some embodiments, phone number panels 7301 may have numbers listed that are currently connected in the conference call. These numbers may be selected individually or in groups to have options applied to them (e.g., hanging up a call). A “Hang up all” option 7305 may be selected to hang up all of the numbers. A “Hang up voice” option 7303 may be selected to hang up the voice callers. A “Hang up video” option 7307 may be selected to hang up the video callers. An “Add call” option 7309 may be selected to dial another number to add to the conference call.

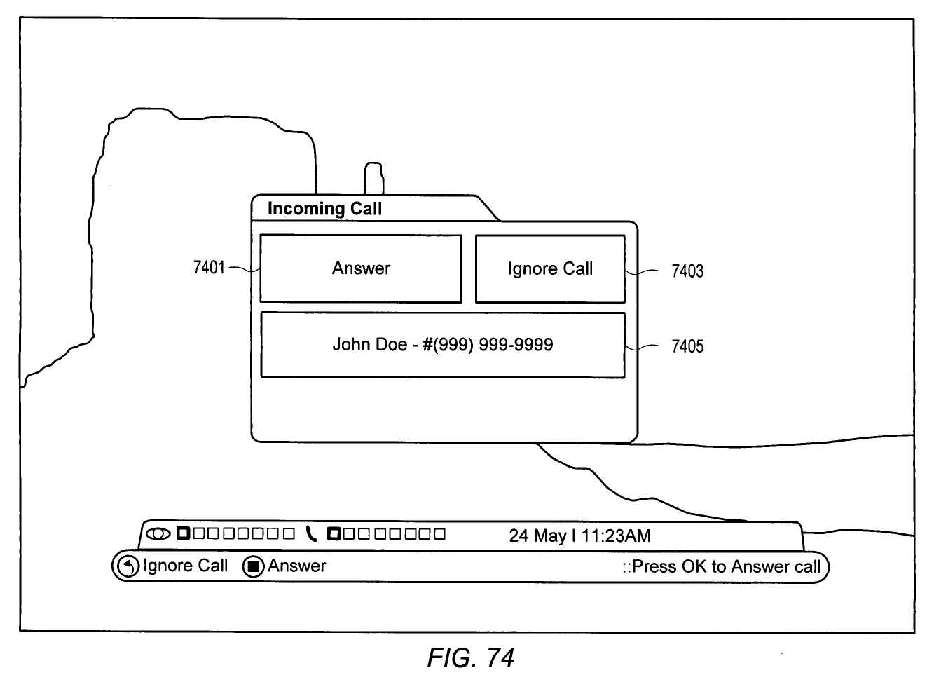

FIG. 74 illustrates a screenshot of receiving a call when no other calls are connected, according to an embodiment. In some embodiments, when a call is received, an incoming call panel with options to “Answer” the call 7401 or “Ignore the call” 7403. In some embodiments, information about the incoming call may be displayed (e.g., in panel 7405). Other options and information may also be used. In some embodiments, the number of the incoming call may also be displayed (not shown).

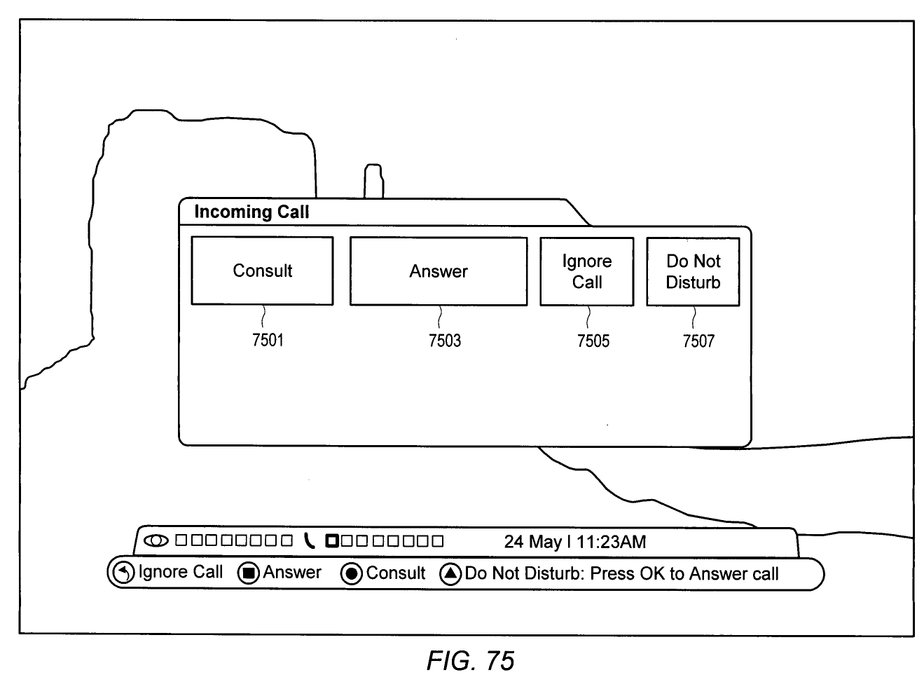

FIG. 75 illustrates a screenshot for incoming calls when at least one other call is already connected, according to an embodiment. In some embodiments, additional options may be provided. For example, an “Answer” option 4713 may answer the incoming call. The “Consult” option 4711 may answer the call but not join it to a current conference. An “Ignore call” option 4715 may be selected to ignore the call. A “Do not disturb” option 4717 may be selected to ignore all future calls until the current call is ended (or, for example, a certain amount of time passes).

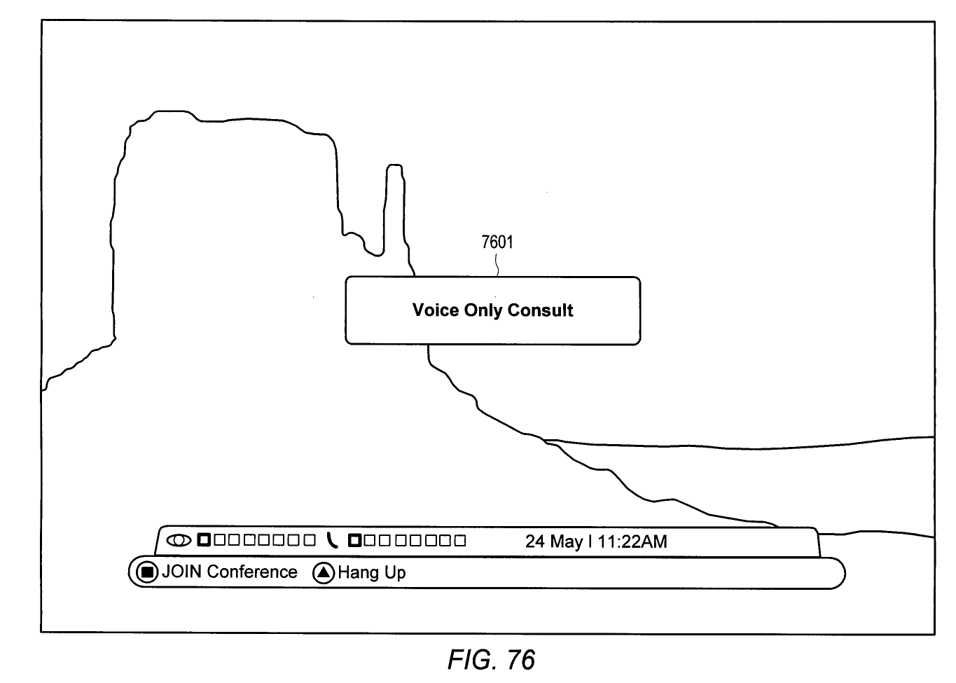

FIG. 76 illustrates a screenshot of a voice only consult, according to an embodiment. In some embodiments, if a “Consult” option 4711 is selected and the incoming call is over the speakerphone, a “Voice only consult” message 7601 may be displayed.

In some embodiments, the video menu (and symbols, shapes, etc. of the menu) may be alpha blended into view, faded in/out, may be translucent, etc. For example, video processing for the screens may use multiple layers (e.g., 16 different layers). Each layer may be alpha blended, faded, etc. Instructions to show various menus, fade menus, etc., may be encoded into the video stream being sent to other video conference systems.

In some embodiments, the menus, etc. may be displayed in a translucent color scheme that shows up even against very light or very dark backgrounds. For example, the translucent color scheme may include a bright and a dark color for displaying the menus. In some embodiments, the video menus/displays may be presented on two (or more) monitors coupled to the video conferencing system.

FIG. 77 illustrates a method for using a speakerphone in a video conference, according to an embodiment. It is noted that in various embodiments one or more of the method elements may be performed concurrently, in a different order, or be omitted. Additional elements may be performed as desired.

At 7701, a video conference may be established for several participant locations. At least one of the participant locations may have a speakerphone incorporated into its video conferencing system. The video conferencing system may receive video/audio data from a participant at a remote location and present the video/audio data to a local participant (e.g., through a display and/or speaker). In some embodiments, the speakerphone may receive user input to manipulate one or more characteristics of the video conference. For example, a user may dial/redial phone numbers, adjust the volume, implement a consult feature, etc. through the speakerphone. In some embodiments, the remote control may also be used to manipulate one or more characteristics of the video conference.

In some embodiments, the speakerphone may provide signals to the video conferencing system based on the received user input to control the one or more characteristics of the video conference. In some embodiments, the speakerphone may have a first plurality of user input elements (e.g., buttons) useable for receiving user input to place and/or receive telephone calls (e.g., a standard phone keypad). In some embodiments, the speakerphone may have a second set of user input elements for receiving user input to manipulate one or more characteristics of the video conference (e.g., additional buttons with other features for manipulating the video conference). In some embodiments, a button pressed on the speakerphone for greater than a predetermined time may specify manipulation of a characteristic of the of the video conference.

At 7703, a speakerphone functionality may be used in the video conference. In some embodiments, the functionality may include sending or receiving signals to or from the speakerphone (e.g., user input signals, microphone signals, and audio signals). In some embodiments, a video call may be placed using the speakerphone. In some embodiments, an audio call may also be placed using the speakerphone. For example, audio call signals may be provided back and forth through the video conferencing system to a Public Switched Telephone Network. In some embodiments, audio signals may be received from microphones in the speakerphone to be used in the video conference. For example, audio from participants in the video conference may be detected through the microphones in the speakerphone. In some embodiments, a speaker signal may be produced through the speakerphone. For example, audio from remote video participants may be produced through the speaker in the speakerphone.

At 7705, a caller may be added to the video conference through user input received through the speakerphone. In some embodiments, the caller may be added through a consult feature that allows a caller to be consulted before being added to the conference or disconnected. For example, the participant locations may be placed on hold. A new participant may be dialed. The new participant may be consulted apart from the other participant locations. The new participant location may be connected to the conference call with the plurality of participant locations or disconnected.

At 7707, other speakerphone functionalities may be used, including dialing a video call, redialing a video call, muting a video call, answering a video call, implementing a call length timer for a video call, adjusting a volume for a video call, terminating a video call, adding a call to an ongoing video conference call, and adjusting a camera for a video call.

FIG. 78 illustrates a method for consulting a participant separate from a video conference, according to an embodiment. It is noted that in various embodiments one or more of the method elements may be performed concurrently, in a different order, or be omitted. Additional elements may be performed as desired.

At 7801, a conference call may be established for a plurality of participant locations. In some embodiments, the conference call may involve video participants and/or speakerphone participants.

At 7803, user input to consult a new participant may be received. In some embodiments, the user input may be received through a speakerphone. In some embodiments, a button signifying a “flash hook” may be pressed by the user.

At 7805, the plurality of participant locations may be placed on hold. The user may then hear a new dial tone.

At 7807, a new participant may be dialed.

At 7809, the new participant may be consulted apart from the plurality of participant locations.

At 7811, a user may choose to either connect the new participant to the conference call with the plurality of participant locations or disconnect the new participant.

In some embodiments, the speakerphone may not have separate video and voice buttons. For example, the speakerphone may use an on/off button for both. In some embodiments, if a user dials another caller, the system may assume the call is an audio call until it receives video (or indication that the remote system supports video). The system may then transition the video components of the system into the call (e.g., the system may display the remote video and may send video from a local camera). In some embodiments, the local camera and display may be inactive if the remote system is an audio only system (or if the remote system is only sending audio). In a multiway call, if the first participant is audio only, the video components (e.g., display and camera) may stay inactive until a second participant who supports video is added. The audio from the first participant may continue to come through the speakerphone while the audio (and video) for the second participant may come through the video conference system.

Audio Output in Video Conferencing and Speakerphone Based on Call Type

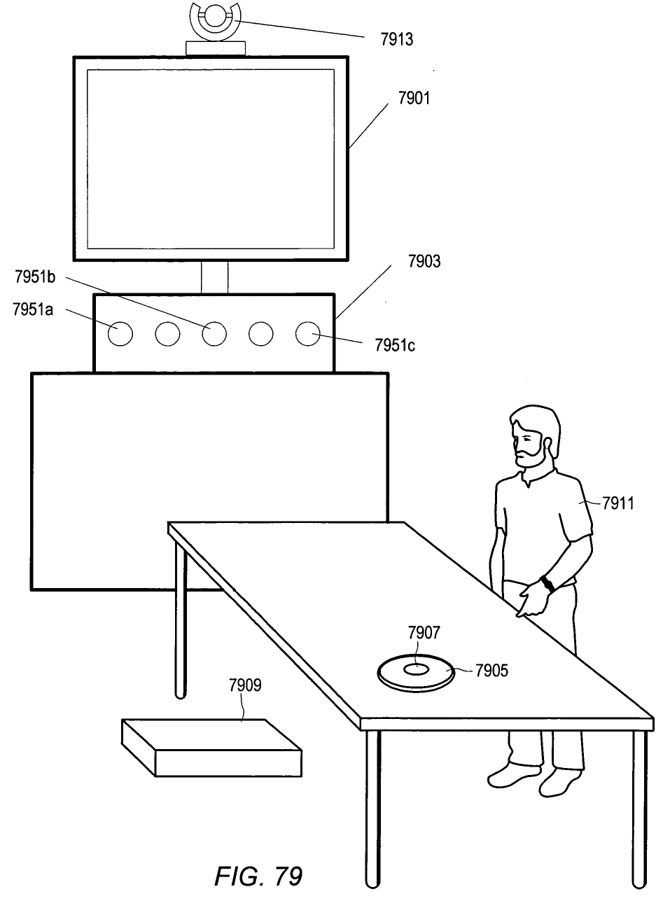

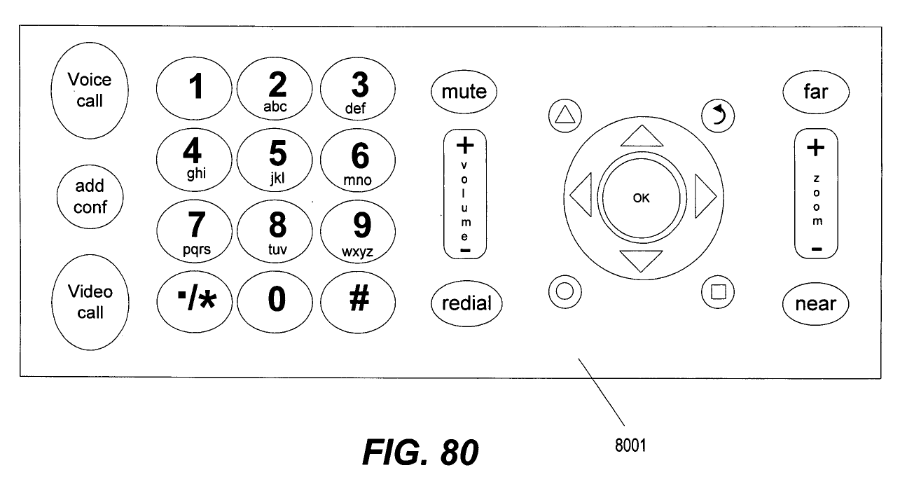

Referring to FIG. 79, in some embodiments, a conference call may involve participants with video conferencing systems and audio participants with speakerphone systems. In some embodiments, sound from speakerphone participants may be sent through a speakerphone sound system 7907 while sound from video participants may be sent through the video sound system 7903 (e.g., near a video monitor 7901). In some embodiments, sound may be localized to only the video sound system 7903 or only the speakerphone sound system 7907. In some embodiments, sound may be localized through a combination of both the video sound system 7903 and the speakerphone sound system 7907 to produce a spatially correct sound field (i.e., video participants heard through the video sound system and speakerphone participants heard through the speakerphone) for in room participants 7911. In some embodiments, the spatially correct sound field may provide a more natural sound experience for the person 7911 in the room. The sound systems may have a selectable audio input with an adjustable output attenuation (i.e., volume control), and some form of sound reproduction (e.g., speaker(s)).

In some embodiments, the components of the video conferencing system and the speakerphone may be coupled wirelessly through the system codec 7909. In some embodiments, other connection mediums (e.g., Ethernet cables) may be used. The system codec 7909 may coordinate the sound production for the video conferencing system and speakerphone.

In some embodiments, the speakerphone may be coupled to the system through a power over Ethernet (POE) cable. The speakerphone may have 16 microphones to provide high quality audio pickup using directional pickup beams from the 16 microphones. Other numbers of microphones may be used. In some embodiments, a speakerphone coupled to the system may provide audio pick-up (i.e., detection) for video and/or audio calls.

In some embodiments, video conferencing systems with an integrated speakerphone may have two distinct sound systems for reproducing the audio of a call, the one attached to and associated with the system's codec functionality (i.e., video sound system 7903), and the speakerphone itself 7905. Video calls may use both video and audio streams during the call, while audio calls may use only audio streams. In some embodiments, the video sound system 7903 may emanate from or appear to emanate from the connected monitor 7901 (e.g., television). In some embodiments, the speakerphone sound system 7907 may emanate from the speakerphone 7905. Distinct locations of the two sound systems may create a directional sound field allowing the persons 7911 within the room to discern from which direction, hence which sound subsystem, the sound emanates.

In various embodiments, both the speakerphone 7905 and the video codec may provide separate means of sound attenuation. The speakerphone 7905 may have a volume up/down button on the device, while the video codec may use a remote control with volume up/down buttons. During homogeneous type (audio or video), single or multi-connection calls, pressing either set of volume control buttons may adjust the attenuation of the sound of the call. In some embodiments, the system may not correlate button sets with a type of call. For example, during an audio only call, pressing the volume up/down buttons on the remote control may adjust the attenuation of the speakerphone sound subsystem 7907. Likewise, during a video call, pressing the volume up/down buttons on the speakerphone may adjust the attenuation of the video call.

FIG. 47 illustrates an integrated unit key pad, according to an embodiment. As can be seen in FIG. 47 similar buttons as found on the remote control and/or speaker phone key pad may be found on the integrated unit key pad 4701. Other buttons may also be placed on the integrated unit key pad.

Integrated Portable High Definition (HD) Video and Audio Conferencing System with Spatial Audio

In some embodiments, the video conference system may have an integrated speakerphone system to manage both a speakerphone and a video conferencing system. For example, a speakerphone and a video conferencing system may be coupled to the integrated video and audio conferencing system 7909 and may receive audio and/or video signals from the integrated unit 7909.

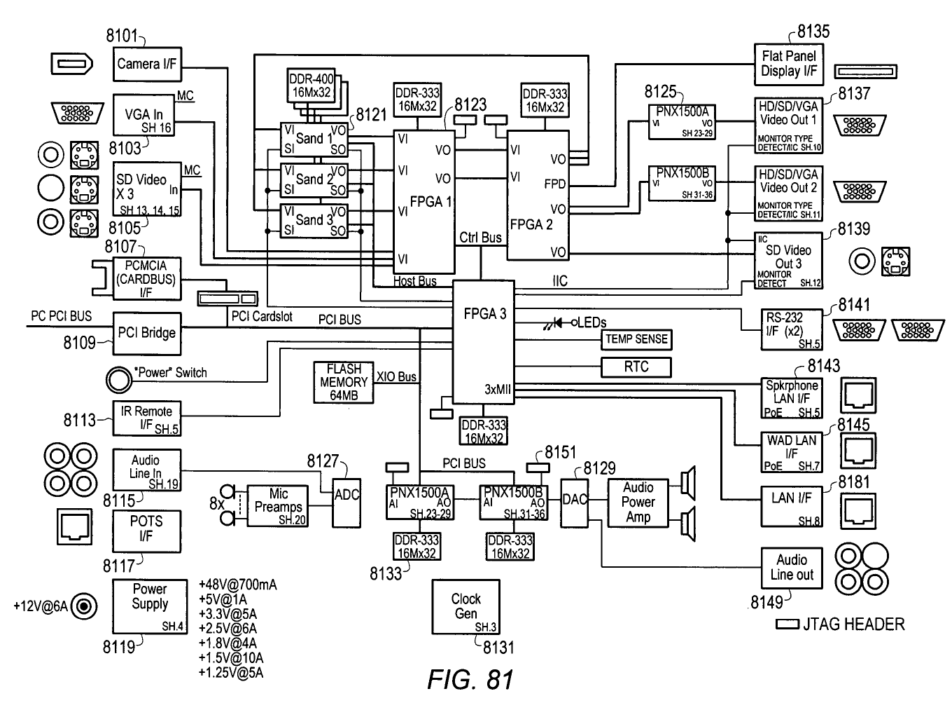

FIG. 81 illustrates a circuit diagram of a video conferencing and speakerphone unit, according to an embodiment. In some embodiments, inputs to the circuit may include a camera interface 8101, a video graphics adapter (VGA) input 8103, a standard video (SD) input (e.g., 3 separate SD inputs) 8105, a Personal Computer Memory Card International Association (PCMCIA) Card interface 8107, a Peripheral Component Interconnect (PCI) bridge 8109, a power switch 8111, an infrared (IR) remote interface 8113, an audio line in 8115, a Plain Old Telephone Service (POTS) interface 8117, and a power supply 8119. As shown, the signals from these interfaces and inputs may be modified using Sands 8121, Field Programmable Gate Array (FPGA) 8123, and other processors (e.g., Phillips Nexperia 1500™ (PNX 1500) 8125). In addition, analog to digital 8127 and digital to analog converters 8129, clocks 8131 (e.g., real time clock and clock generator), and memory 8164 (e.g., double data rate (DDR), flash memory, etc) may also be used. In some embodiments, outputs may include a flat panel display interface 8166, an HD/SD/VGA video out 8168 (e.g., multiple video outs), an SD video out 8170, an RS-232 port 8172, a speakerphone local area network (LAN) interface 8174, a Wireless Access Device (WAD) LAN interface 8176, a LAN interface 8181, and an audio line out 8149. Other inputs and outputs are also contemplated. Joint Test Action Group (JTAG) 8151 may also be used.

In some embodiments, an integrated fixed focus high definition lens and image sensor may be used (e.g. to deliver 1280×720 resolution at 30 frames per second (fps)). The system may also use two high quality long travel 1-inch diameter ported speakers with a frequency response of approximately 150 Hz to 22 kHz. Other speakers may also be used. In some embodiments, low noise microphones may be used at positions supporting either broad-fire or end-fire microphone array processing. In some embodiments, approximately 8 low noise microphones may be used (other numbers of microphones are also contemplated). The microphones may detect audio from a user (who may typically be approximately 3′ to 5′ from the system). Audio algorithms may direct the microphone array at the user speaking and minimize background noise and reverberation. Additional beam forming algorithms may be used to determine the horizontal angle of the user with respect to the system.

In some embodiments, the optimum viewing distance by someone with normal vision may be where the resolving power of the eye is just equal to the pixel pitch of the image. At that distance the image may appear as sharp as a live image. At closer distances, the image may appear blurry and at farther distances, some of the resolution may be wasted. Someone with normal eyesight may resolve about 1/60 of degree of arc. In some embodiments, the optimal viewing distance in inches may be calculated as approximately 3438/(pixel pitch) where the pixel pitch is the number of pixels on the monitor per inch. Other formulas for the optimal viewing distance are also contemplated. In some embodiments, a screen diagonal of approximately 17 inches with an aspect ratio of approximately 16:9 may be used. A video resolution of 1280×720 for a screen of 14.8×8.3 (width vs. height) may result in the optimum viewing distance of approximately 40 inches (3.3 feet). In some embodiments, for room systems, a screen diagonal approximately in the range of 50″ to 60″ may be used with an aspect ratio of 16:9. Other diagonals and aspect ratios may also be used. In some embodiments, the video resolution for the 50″ screen may be approximately 1280×720, with a screen width vs. height of 43.6×24.5 and an optimal viewing distance of 117 inches (9.7 feet). The optimal viewing distance of 9.7 feet may roughly match a typical viewing distance in a conference room.

In some embodiments, spatially realistic audio may be provided for a video call. In some embodiments, voices coming from the people on the left side of the screen, in a video call, may be directed through audio on the left side of the screen (e.g., at least speaker 7951a) at the unit on the other end (similarly for voices from the center (speaker 7951b) and right side (speaker 7951c) of the screen). This may result in giving the user a realistic audio experience that may match the realism of the video experience. In some embodiments, audio from a speakerphone (for example, from a speakerphone only audio participant) may come through only the speakerphone. In some embodiments, the audio from the audio only participants may be provided through other speakers on the system.

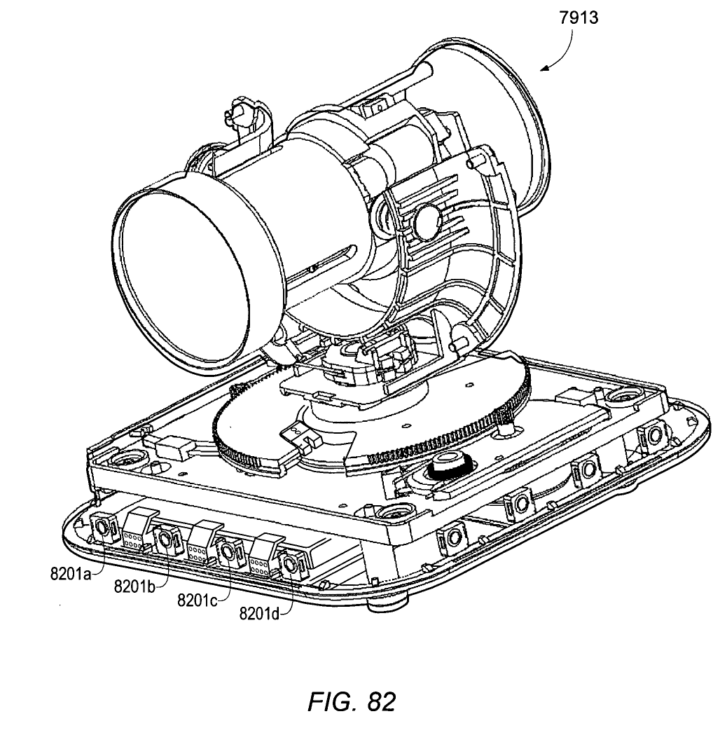

In some embodiments, two speakers may be used in the system to create synthesized stereo sound at a location specified by position information received as side information along with the existing single audio channel. As seen in FIG. 82, the location may be determined by using beam forming with integrated microphones 8201 on the camera 7913 (an internal view of the camera 7913 is shown in FIG. 82). For example, information sent with the audio signal may indicate the audio came principally from the left side of the system. Other numbers and locations of the integrated microphones 8201 may also be used. The audio signal may then be sounded over speakers primarily on the left side of the displaying system. In some embodiments, the sound may be produced from speakers on the system that are directed towards the left side of the system (i.e., pointed to the left). Other speaker configurations are also contemplated.

In some embodiments, a true stereo echo canceller may not be required. For example, an independent echo canceller may be used for each virtual talker position. In some embodiments, five systesized talker locations may be used across the display (other numbers of systesized talker locations may also be used). Each may be on or off resulting in a 32 collective virtual talker positions and 32 independent echo cancellers. Other numbers of collective virtual talker positions and independent echo cancellers may be used. When a set of talker positions is active, a corresponding echo canceller may be activated. In some embodiments, the compute of the system may not become large because only one echo canceller may be executing at any one time.

In some embodiments, a true stereo echo canceller may be used. For example, a 3-channel or higher echo canceller may be used (a lower channel echo canceller may also be used). A beam former may be applied to the integrated microphones 8201 to generate a left and a right beam (or left, center, and right for a 3-channel echo canceller). The beams may become inputs to the left and right channels of the echo canceller. In some embodiments, beams determined by the integrated microphones 8201 in the camera 7913 may be continuously correlated with the beams locating the talker around the speakerphone. Depending on the visual field of the camera 7913, the correct speakerphone beams may be used to produce left and right audio channels. In some embodiments, the speakerphone beam former may generate a left and right beam (or left, center, and right beam for a 3 channel echo canceller). In some embodiments, these beams may become inputs to the left and right channels for the echo canceller. In some embodiments, audio beams used for the left and right channel coming from the speakerphone may provide better audio separation due to the high quality beams. In addition, they may eliminate the need to have two separate microphones for left and right channels placed in specific locations on the table.

In some embodiments, audio beams may be used for left and right channels to provide better audio separation and eliminate the need to have two separate microphones placed on the table in front of the unit (as opposed to just left and right microphones). In some embodiments, left and right microphones may also be used.

Embodiments of these methods may be implemented by program instructions stored in a memory medium or carrier medium. A memory medium may include any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer that connects to the first computer over a network, such as the Internet. In the latter instance, the second computer may provide program instructions to the first computer for execution. The term “memory medium” may include two or more memory mediums that may reside in different locations, e.g., in different computers that are connected over a network.

In some embodiments, the computer system may include a memory medium(s) on which one or more computer programs or software components according to one embodiment of the present invention may be stored. For example, the memory medium may store one or more programs that are executable to perform the methods described herein. The memory medium may also store operating system software, as well as other software for operation of the computer system.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method, comprising:
establishing a video conference for at least two participant locations, wherein at least one participant location of the at least two participant locations has a video conferencing system and a speakerphone;
using a speakerphone functionality in the video conference, wherein the functionality comprises sending or receiving signals to or from the speakerphone.

2. The method of claim 1, wherein using the speakerphone functionality comprises receiving user input by the speakerphone for manipulating one or more characteristics of the video conference.

3. The method of claim 1, wherein using the speakerphone functionality further comprises the speakerphone providing signals to the video conferencing system to manipulate one or more characteristics of the video conference.

4. The method of claim 1, further comprising:
placing an audio call using the speakerphone, wherein the audio call signals are provided through the video conferencing system to a Public Switched Telephone Network.

5. The method of claim 1, further comprising:
adding a caller to the video conference, wherein the caller is added to the video conference through user input received through the speakerphone.

6. The method of claim 1, further comprising:
placing the plurality of participant locations on hold;
dialing a new participant;
consulting the new participant apart from the plurality of participant locations; and
connecting the new participant to the conference call with the plurality of participant locations.

7. The method of claim 1, wherein using the speakerphone functionality comprises receiving audio signals from microphones in the speakerphone.

8. The method of claim 1, wherein using the speakerphone functionality comprises producing a speaker signal to the speakerphone.

9. The method of claim 1, wherein using the speakerphone functionality comprises receiving user input through the speakerphone, wherein the user input facilitates one or more of:
dialing a video call;
redialing a video call;
muting a video call;
answering a video call;
implementing a call length timer for a video call;
adjusting a volume for a video call;
terminating a video call;
adding a call to an ongoing video conference call; and
adjusting a camera for a video call.

10. A system, comprising:
a video conferencing system operable to receive video and audio data from a participant at a remote location and present the video and audio data;
a speakerphone coupled to the video conferencing system, wherein the speakerphone is operable to:
receive user input to manipulate one or more characteristics of the video conference; and
provide signals to the video conferencing system based on the received user input to control the one or more characteristics of the video conference.

11. The system of claim 10, wherein the speakerphone comprises a first plurality of user input elements useable for receiving user input to place and/or receive telephone calls;
wherein the speakerphone comprises a second one or more user input elements useable for receiving user input to manipulate one or more characteristics of the video conference.

12. The system of claim 10, wherein the user input elements are buttons and wherein a button pressed for greater than a predetermined time specifies manipulation of a characteristic of the of the video conference.

13. The system of claim 10, further comprising an Ethernet cable coupling the speakerphone to the video conference system, wherein the speakerphone is configured to communicate with the video conferencing system over the Ethernet cable.

14. A speakerphone, comprising:
one or more microphones;
one or more speakers;
a port for coupling to a telephone jack; and
a plurality of user input elements for receiving user input to manipulate one or more characteristics of a video conference.

15. The speakerphone of claim 14, wherein the microphones receive audio from a participant, and wherein audio signals from the microphones are used in the video conference call.

16. The speakerphone of claim 14, wherein the one or more speakers is used to reproduce audio received in a video conference call.

17. The speakerphone of claim 14, wherein the speakerphone facilitates one or more of:
dialing a video call;
redialing a video call;
muting a video call;
answering a video call;
implementing a call length timer for a video call;
adjusting a volume for a video call;
terminating a video call;
adding a call to an ongoing video conference call; and
adjusting a camera for a video call.

18. The speakerphone of claim 14, wherein the speakerphone further comprises and Ethernet cable to couple the speakerphone to a video conferencing system.

19. The speakerphone of claim 18, wherein the speakerphone is configured to communicate with the video conferencing system over the Ethernet cable.
